(19) United States
(12) Patent Application Publication
(10) Pub. No.: US 2026/0136079 A1
(43) Pub. Date: May 14, 2026

(54) IMAGE GENERATING METHOD, APPARATUS, ELECTRONIC DEVICE, STORAGE MEDIUM

(71) Applicant: SAMSUNG ELECTRONICS CO., LTD., Suwon-si (KR)

(72) Inventors: Lingling GE, Jiangsu (CN); Dai CAO, Jiangsu (CN); Youxin CHEN, Jiangsu (CN); Hao WU, Jiangsu (CN); Ying GE, Jiangsu (CN)

(73) Assignee: SAMSUNG ELECTRONICS CO., LTD., Suwon-si (KR)

(21) Appl. No.: 19/175,634

(22) Filed: Apr. 10, 2025

Related U.S. Application Data
(63) Continuation of application No. PCT/KR2025/003688, filed on Mar. 24, 2025.

(30) Foreign Application Priority Data
Nov. 8, 2024 (CN) 202411595109.4

(51) Int. Cl. H04N 21/84; H04N 21/4223; H04N 21/45; H04N 21/466; H04N 21/845

(52) U.S. Cl. CPC H04N 21/84; H04N 21/4223; H04N 21/4532; H04N 21/4666; H04N 21/845

(57) ABSTRACT

An image generating method includes receiving multimedia data and user information of a current user of the multimedia data, determining description words of the multimedia data, based on the multimedia data and the user information, generating a description image of the multimedia data, based on the description words, and applying the description image to a detail page of the multimedia data.

### CROSS-REFERENCE TO RELATED APPLICATIONS

This application is a continuation application of International Application No. PCT/KR2025/003688, filed on Mar. 24, 2025, which claims priority to Chinese Patent Application No. 202411595109.4, filed on Nov. 8, 2024, in the China National Intellectual Property Administration, the disclosures of which are incorporated by reference herein in their entireties.

### BACKGROUND

### 1. Field

The present disclosure relates generally to image processing, and more particularly, to an image generating method, an apparatus, an electronic device, a storage medium, and a program product.

### 2. Description of Related Art

Related electronic devices such as, but not limited to, smart appliances (e.g., voice-controlled virtual assistants, set-top boxes (STBs), refrigerators, air conditioners, microwaves, televisions (TVs), or the like), mobile devices (e.g., user equipment (UE), laptop computers, tablet computers, personal digital assistants (PDAs), smart phones, cell phones, or the like) may introduce a video to be played using a video detail page that may be similar to the screen 100 shown in FIG. 1. The screen 100 may include different widgets (e.g., a first widget 112A, a second widget 112B, a third widget 112C, and a fourth widget 112D) that may be limited to displaying simple text introductions in a fixed format (e.g., ratings and type labels in the first widget 112A) that may be added at most, with a single content 110. For example, the widgets may be limited by a lack of available copyrighted resources that may not be sufficient to support a higher quality video detail page. However, the use of relatively high-quality images may incur in relatively high labor and/or resource (e.g., processing resources, memory resources, or the like) costs to operate and/or maintain these screens.

Recent developments in artificial intelligence (AI) technology may provide for the generation of artificial intelligence generated content (AIGC) that may be able to generate images in batches at a comparatively lower cost. However, related AIGC may exhibit a significant level of randomness that may not be suitable for use of such automatically generated content in video display screens similar to the screen 100, for example.

Thus, there exists a need for further improvements in AIGC technology, as the need for automatically generating high-quality images may be constrained by a significant level of randomness in the images. Improvements are presented herein. These improvements may also be applicable to other AI image generation technologies.

### SUMMARY

One or more example embodiments of the present disclosure provide an image generating method, an apparatus, an electronic device, a storage medium, and a program product.

The technical goals to be achieved by the present disclosure may not be limited to technical goals described above, and other technical goals may be clearly understood by those skilled in the art from the following descriptions.

According to an aspect of the present disclosure, an image generating method includes receiving multimedia data and user information of a current user of the multimedia data, determining description words of the multimedia data, based on the multimedia data and the user information, generating a description image of the multimedia data, based on the description words, and applying the description image to a detail page of the multimedia data.

According to an aspect of the present disclosure, an image generating apparatus includes one or more processors including processing circuitry, and a memory storing instructions. The instructions, when executed by the one or more processors individually or collectively, cause the image generating apparatus to receive multimedia data and user information of a current user of the multimedia data, determine description words of the multimedia data, based on the multimedia data and the user information, generate a description image of the multimedia data, based on the description words, and apply the description image to a detail page of the multimedia data.

According to an aspect of the present disclosure, an electronic apparatus includes at least one processor, and at least one memory storing computer-executable instructions. The computer-executable instructions, when executed by the at least one processor, cause the electronic apparatus to receive multimedia data and user information of a current user of the multimedia data, determine description words of the multimedia data, based on the multimedia data and the user information, generate a description image of the multimedia data, based on the description words, apply the description image to a detail page of the multimedia data, determine, based on receipt of updated scenario information, whether to trigger at least one of an update scenario mode or a reset scenario mode according to the updated scenario information, based on a determination to trigger the update scenario mode, adjust, based on the updated scenario information, an updated description image of the multimedia data, and based on a determination to trigger the reset scenario mode, receive new multimedia data and new user information of the current user of the new multimedia data, determine new description words of the new multimedia data, generate a new description image of the new multimedia data, based on the new description words, and apply the new description image to the detail page of the multimedia data.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a schematic diagram of a video detail page, according to an embodiment of the present disclosure;

FIG. 2 is a flowchart of an image generating method, according to an embodiment of the present disclosure;

FIG. 3 is a schematic diagram of a mask of an image template, according to an embodiment of the present disclosure;

FIG. 4 is a schematic flowchart of an image generating method, according to an embodiment of the present disclosure;

FIG. 5 is a schematic flowchart of determining description words, according to an embodiment of the present disclosure;

FIG. 6 is an example of a description image of a television series, according to an embodiment of the present disclosure;

FIG. 7 is an example of a description image of a television series, according to an embodiment of the present disclosure.

FIG. 8 is a schematic flowchart of a redirection of description words, according to an embodiment of the present disclosure;

FIG. 9 is a schematic flowchart of generating an element image, according to an embodiment of the present disclosure;

FIG. 10 is a schematic diagram of a principle of generating element images, according to an embodiment of the present disclosure;

FIG. 11 is a schematic diagram of an execution flow of a scenario monitoring module, according to an embodiment of the present disclosure;

FIG. 12 is a schematic flowchart of fusing element images, according to an embodiment of the present disclosure;

FIG. 13 is an example of a description image of a movie, according to an embodiment of the present disclosure.

FIG. 14 is an example of a description image of a movie, according to an embodiment of the present disclosure;

FIG. 15 is an example of a description image of a movie, according to an embodiment of the present disclosure;

FIG. 16 is a schematic diagram of a video detail page of a television series in a cell phone, according to an embodiment of the present disclosure;

FIG. 17 is a schematic diagram of a video detail page of a television series in a tablet computer, according to an embodiment of the present disclosure;

FIG. 18 is a schematic diagram of a video detail page of a television series in a tablet computer, according to an embodiment of the present disclosure;

FIG. 19 is a schematic diagram of a page of a cell phone searching a desktop widget, according to an embodiment of the present disclosure;

FIG. 20 is a block diagram of an image generating apparatus, according to an embodiment of the present disclosure; and

FIG. 21 is a block diagram of an electronic device, according to an embodiment of the present disclosure.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, terms such as, but not limited to, “first”, “second”, or the like in the present disclosure may be used to distinguish similar objects rather than to describe a particular order or sequence. It is to be understood that data so distinguished may be interchanged, where appropriate, so that embodiments of the present disclosure described herein may be implemented in an order other than those illustrated or described herein. Embodiments described in the following examples may not represent all embodiments that are consistent with the disclosure. Rather, the embodiments may only be examples of devices and/or methods that may be consistent with some aspects of the disclosure, as detailed in the appended claims.

As used herein, a phrase such as “at least one of the several items” may include “any one of the several items”, “any combination of the several items”, “all of the several items”, and/or the juxtaposition of these three categories. For example, the phrase “performing at least one of operation one or operation two” may refer to the following juxtapositions: (1) performing operation one only; (2) performing operation two only; (3) performing both operation one and operation two.

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

As used herein, when an element or layer is referred to as “covering” or “overlapping” another element or layer, the element or layer may cover at least a portion of the other element or layer, where the portion may include a fraction of the other element or may include an entirety of the other element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, an image generating method, an apparatus, an electronic device, and a storage medium according to various embodiments of the present disclosure are described with reference to the accompanying drawings.

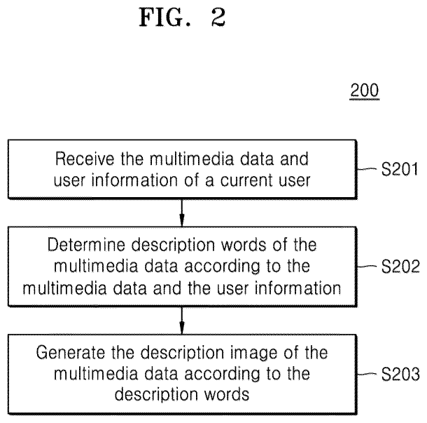

FIG. 2 is a flowchart of an example of an image generating method, according to an embodiment of the present disclosure. The image generating method 200 may be used to generate a description image of multimedia data that may be applied to a detail page of the multimedia data, a screen saver page of an electronic device, a page of multimedia recommendation widgets of the electronic device, or the like, so as to facilitate an introduction of the multimedia data in a more enriched form in these pages. The image generating method 200 may be implemented in a device having sufficient computing power, for example, an electronic device that may play the multimedia data, such as, but not limited to, a mobile device (e.g., a user equipment (UE), a laptop computer, a tablet computer, a personal digital assistant (PDA), a smart phone, a cellular phone, or the like), smart appliance (e.g., a voice-controlled virtual assistant, a set-top boxes (STB), a refrigerator, an air conditioner, a microwave, a television (TV), or the like), a wearable device (e.g., smart watch, headset, headphones, or the like), an Internet of Things (IoT) device, or the like. As another example, the image generating method 200 may be implemented in a desktop computer, a computer server, a virtual machine, a network appliance, or the like. In such an example, a server may communicate with an electronic device through a communication network and transmit the generated description image to the electronic device.

Referring to FIG. 2, in operation S201, multimedia data and user information of a current user may be received.

The multimedia data may refer to data whose description image may need to be generated, for example, a television series, a movie and/or a song that may be played, which may include video images and/or frames, audio data (e.g., music), voice data (e.g., spoken dialogue), or the like therein. The multimedia data may also include images and/or data related to the multimedia data, such as, but not limited to, a promotional poster thereof. The current user may refer to a viewer user of the multimedia data, that is, a user who is using the above-described electronic device, for example. In an embodiment, the user information may be determined through a user account logged in on the electronic apparatus. Alternatively or additionally, the user information may be determined by other reasonable means. That is, the present disclosure may not be limited thereto. It is to be noted that the user information (including, but not limited to, user device information, user personal information, or the like) described in the present disclosure may refer to information that is authorized by the user and/or fully authorized by the involved parties.

In operation S202, description words of the multimedia data are determined according to the multimedia data and the user information. For example, operation S202 may include to determine the description words based on a natural language processing technique. In an embodiment, the description words may include words of at least one form such as, but not limited to, keywords, phrases, sentences, and/or paragraphs. That is, the present disclosure may not be limited thereto.

In operation S203, the description image of the multimedia data may be generated according to the description words. This operation may realize, based on the artificial intelligence generated content (AIGC) technology, an image generation in combination with word conditions.

According to the image generating method 200 of an embodiment of the present disclosure, the description words of the multimedia data that match the current user may be determined based on the targeted multimedia data and the user information of the current user, and the description image of the multimedia data may be generated based on the description words. Consequently, the description image may match more closely with the viewing needs of the current user, thereby potentially reducing the randomness of the automatically generated image and/or potentially improving the quality of the automatically generated image, such that the description image may support various pages related to the multimedia data with relatively low operating cost, when compared to related automatic image generation methods.

According to embodiments, the data transmission between different executing entities of the image generating method 200 may differ. For example, the electronic device may access, via a communication network, the multimedia data to be played from a multimedia server and/or may access, via the communication network, the user information from a user management server, where the multimedia server and the user management server may be the same server or may be different servers belonging to the same server cluster and/or may be different unrelated different servers. Accordingly, the electronic device may determine the description words of the multimedia data and/or generate the description image, which may also be displayed on an appropriate page.

As another example, the multimedia server and/or the user management server may be used directly, or a separately configured server may be used. In such an example, a server may use its own stored multimedia data and/or user information and/or access the multimedia data and/or the user information from another server (e.g., the multimedia server and/or the user management server). Furthermore, the server may determine the description words of the multimedia data and/or may generate the description image, and may transmit the description image to the electronic device and instruct the electronic device to display the description image on an appropriate page.

Continuing to refer to FIG. 2, in some embodiments, operation S203 may include applying the description words as keywords in order to generate an image that may match the keywords and designating the generated image as the description image of the multimedia data.

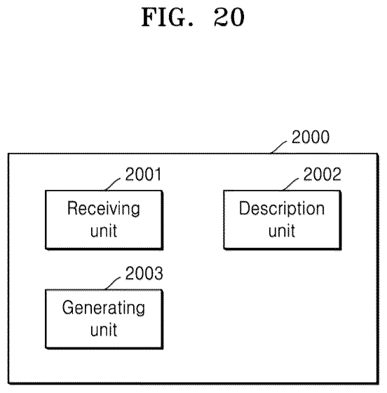

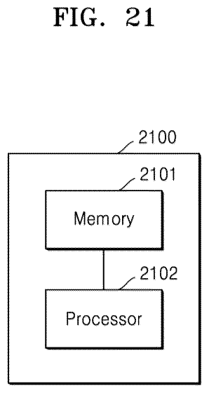

Alternatively or additionally, operation S203 may include obtaining (e.g., receiving from an external device using a receiving unit (e.g., a receiving unit 2001 illustrated in FIG. 20) or retrieving from an internal storage medium (e.g., a memory 2101 illustrated in FIG. 21) storing one or more preset image templates) an image template that may include a plurality of preset elements, determining element description words for each of the plurality of preset elements based on the description words, generating an element image of each preset element according to the element description words for each preset element, and generating the description image of the multimedia data according to the element image of each preset element. By preparing the image template including the plurality of preset elements (e.g., a title, an introduction text, a background image, or the like) in advance, the element images of respective preset elements may be generated according to the template, and these element images may be combined into the description image, which may result in a uniform layout form of the generated description image, and which may further reduce the randomness of the automatically generated description image, and as such, may potentially improve the accuracy and/or stability of the automatically generated description image, when compared to related automatic image generation methods. In addition, corresponding element description words may be determined for each preset element based on previously obtained description words, which may provide clearer and/or more specific instructions, and thereby, may potentially further improve the quality of the description image.

For example, when determining the element description words for each of the plurality of preset elements based on the description words, for each preset element, words that may be suitable for the preset element may be extracted from all the description words as the element description words for the preset element. That is, determining the element description words may include redirecting (e.g., rephrasing) the description words based on the preset element without substantially changing the content of the description words. As a result, there may be overlap in the element description words of different preset elements. For example, the same words may be reused by two (2) or more preset elements.

In an embodiment, each of the plurality of preset elements may include element configuration information. The element configuration information may include an element name (e.g., names of a title, an introduction text, a background image, or the like) and an element display region that may represent a display region covered by the corresponding element image in the entire description image, so as to facilitate combination of the element images of respective preset elements. The element configuration information may also include other information to enrich the description of the preset elements. That is, the present disclosure is not limited as to the information included in the element configuration information.

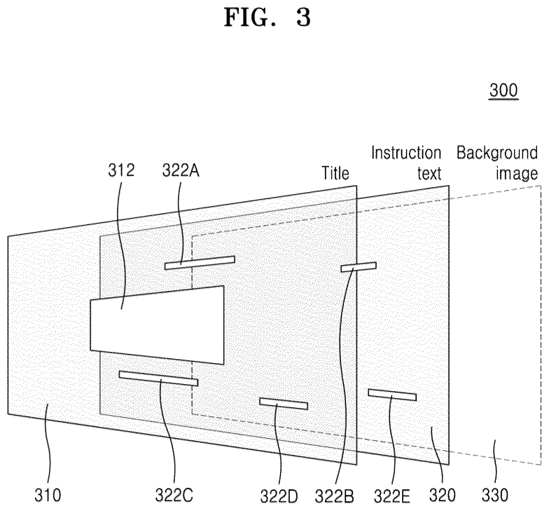

In an embodiment, a mask may be constructed for each preset element for representing the element display region. FIG. 3 illustrates an example of masks of an image template 300 that includes three (3) preset elements. As shown in FIG. 3, a title mask 310 may correspond to a first preset element of the image template 300, an introduction text 320 may correspond to a second preset element of the image template 300, and a background image 330 may correspond to a third preset element of the image template 300. That is, each mask may be designed corresponding to each preset element, in which a dark region may indicate a region that is not filled with the image, and a transparent region may indicate a region that needs to be filled with the image. As used herein, the transparent region may be referred to as the element display region. Accordingly, the operation of generating the element image of each preset element according to the element description words for each preset element in operation S203 may include generating a complete image of each preset element according to the element description words and the element configuration information of each preset element. A size of the complete image may match a size of the description image. That is, the size of the complete image may be substantially similar and/or the same as the size of the description image. Alternatively, the size of the complete image may be proportional to the size of the description image so as to facilitate scaling the complete image proportionally to be substantially similar and/or the same as the size of the description image. The operation S203 may further include generating the element image of each preset element based on the complete image and the element display region of each preset element. For example, operation S203 may include clipping out portions of the non-filled region (e.g., the dark region) according to the mask, and retaining only the portions of the filled region (e.g., the transparent region) as the element image. By generating the complete image for the entire display region, and subsequently generating the element image in conjunction with the element display region, it may be possible to break down the composite task of generating the element image of different sizes and different display regions into two (2) simple tasks, namely, the task of generating the complete image of a uniform size based on the words, and the task of cropping the complete image to obtain the element image, which may potentially reduce the difficulty of the task and potentially improve the efficiency of task execution, when compared to related automated image generation methods.

For example, as shown in FIG. 3, the element image of the title may be filled in a rectangular region 312 in the center of the entire display region, the element image of the introduction text may be divided into several sections to be filled in a plurality of dispersed small-sized striped regions (e.g., a first region 322A, a second region 322B, a third region 322C, a fourth region 322D, and a fifth region 322E) in the display region, and the element image of the background image may be filled in the entire display region 330.

In an embodiment, the operation S203 may also include adjusting, based on a fusion effect of the complete images of the plurality of preset elements, the complete image of at least one preset element of the plurality of preset elements to obtain a corrected complete image of each of the plurality of preset elements, and generating the element image of each preset element based on the corrected complete image and the element display region of each preset element. Considering that the element display regions (e.g., the rectangular region 312, the first to fifth regions 322A to 322E) of different preset elements may overlap and that the complete images of respective preset elements may be generated independently, if the element images are obtained by directly clipping out portions of the non-filled region and overlapping respective element images, a resulting description image may be unclear due to the overlapping display regions after fusion. Consequently, by adjusting at least one complete image based on the fusion effect of the complete images (e.g., taking into account a clarity degree of content display of each element image as a measurement standard of the fusion effect), and then clipping the images based on the corrected complete images after the adjustment, to obtain the element images, it may be possible to generate a clear description image and potentially improve the quality of the image generation. For example, the adjustment of the complete image may include moving the position of partial images. As another example, the adjustment of the complete image may include adjusting the image color of the overlapping regions. However, the present disclosure is not limited in this regard, and the complete image may be adjusted using various adjustment methods without departing from the scope of the present disclosure.

As used herein, for the convenience of unified description, the complete image that is ultimately used to generate the element image may be referred to as the corrected complete image, regardless of whether the complete image of the preset element has been adjusted. That is, for the preset element for which no adjustment is made to the complete image, the complete image and the corrected complete image thereof may be the same image. However, when the fusion effect is relatively poor, in addition to adjusting the complete image to improve the fusion effect, the element display region of the at least one preset element may be further modified and/or adjusted according to other reasonable implementations. In addition, these implementations may be used in combination without contradicting each other, and the present disclosure may not be limited thereto.

In an embodiment, operation S203 may further include determining, from element images of the plurality of preset elements, dynamic element images and static element images, fusing the dynamic element images to a dynamic layer and the static element images to a static layer, respectively, and merging the dynamic layer and the static layer to the description image of the multimedia data, wherein the dynamic layer may be capable of being regenerated. By distinguishing the plurality of element images into the dynamic element images that may be regenerated and the static element images that may remain unchanged, and fusing the dynamic element images into the dynamic layer and the static element images into the static layer, respectively, it may be possible to generate a new description image by changing the dynamic layer (e.g., by changing at least a portion of the dynamic element images) when the requirements change, while maintaining the static layer unchanged, thereby potentially improving flexibility and/or potentially reducing a computational cost needed to generate a completely new description image. In addition, randomness of the image generation may be potentially prevented and/or reduced, as well as, potentially improving the stability of the static layer of the description image, thereby providing a balance between flexibility and stability in the generation of the description image.

For example, when redirecting the description words based on the preset elements, each preset element may be redirected to obtain a large number of element description words, and when generating the element image according to the element description words (e.g., when generating the dynamic element image), it may not be necessary to use all the element description words of one preset element to generate the element image of the preset element, and instead, at least one element description word of the preset element may be extracted for generating the element image of the preset element. When the dynamic layer needs to be changed as the requirements change, for the at least one dynamic element image that needs to be changed, the at least one element description word that meets the requirements may be re-selected from all the element description words of the preset element corresponding to the dynamic element image, and the element image may be regenerated accordingly as the updated dynamic element image for replacing the original dynamic element image of the preset element. As another example, format (e.g., non-substantive) adjustments to the dynamic element image may be made while the substantive content thereof remains unchanged. Consequently, it may be unnecessary to repeatedly perform the operations of determining the description words, determining the element description words, and generating the element image, which may potentially improve the efficiency of updating the description image.

In an embodiment, a new complete image may be generated based on the re-selected element description words, and a new corrected complete image may be obtained by adjusting at least one of the complete images based on the fusion effect of the new complete image, and as such, the complete images corresponding to other dynamic element images may not need to be changed. For example, only the new complete image may be adjusted, which may also allow for the other dynamic element images to remain unchanged. Subsequently, the new complete image may be clipped to obtain a new dynamic element image.

In an embodiment, a number of the preset elements may be labeled as dynamic elements and a number of other preset elements may be labeled as static elements in advance. Accordingly, operation S203 may further include determining the element images of the dynamic elements as the dynamic element images, and determining the element images of the static elements as the static element images.

Operation S203 may also include acquiring scenario information, and determining, according to the scenario information, the dynamic element images and the static element images from among the element images of the plurality of preset elements. The dynamic layer may be capable of being regenerated when the scenario information changes. The scenario information may be related to the current user and a viewing behavior of the current user for the multimedia data. By introducing the scenario information, determination of the dynamic element images and the static element images may be realized more flexibly in accordance with the actual image generation requirements in different scenarios, so that the description images may be updated more efficiently when the requirements change. For example, the dynamic elements and the static elements may be determined from the plurality of preset elements according to the scenario information rather than in advance independently of the scenario information. That is, according to different scenario information, a same preset element may be determined as a dynamic element and/or may be determined as a static element.

In an embodiment, the image generating method 200 may further include determining, in response to receiving updated scenario information, whether to trigger an update scenario mode or a reset scenario mode according to the updated scenario information. In the case of determining to trigger the update scenario mode, the image generating method 200 may include adjusting, according to the updated scenario information, the dynamic element images to obtain updated dynamic element images, fusing the updated dynamic element images to an updated dynamic layer, and merging the updated dynamic layer and the static layer to an updated description image of the multimedia data. As used herein, for the convenience of description, all the dynamic element images obtained after triggering the update scenario mode may be referred to as the updated dynamic element images, even if, according to the requirements of the scenario, only some of the dynamic element images may be adjusted.

Alternatively or additionally, in the case of determining to trigger the reset scenario mode, the image generating method 200 may include re-executing operation S201 to operation S203. That is, the image generating method 200 may include re-executing from the operation of receiving the multimedia data and the user information of the current user, to the operation of generating the description image of the multimedia data according to the description words.

By configuring the update scenario mode and the reset scenario mode, it may be possible to identify whether the update of the description image may be realized by changing the dynamic layer when the update of the scenario information occurs, and trigger the update scenario mode when it is determined that the update may be realized, where only the dynamic layer is updated, and/or trigger the reset scenario mode when it is determined that the update may not be realized, where the entire description image is regenerated, which realizes the update of the description image as needed and may potentially further improve the efficiency of the updating operations.

For example, when determining whether to trigger the update scenario mode or the reset scenario mode, a number of a priori rules may be preset in advance, for example, a rule for triggering the update scenario mode, and a rule for triggering the reset scenario mode, so that it may be determined which mode to trigger according to whether the updated scenario information satisfies the priori rules or not. In an embodiment, if the priori rule for triggering the update scenario mode is not satisfied, the reset scenario mode may be triggered. Alternatively or additionally, if the priori rule for triggering the reset scenario mode is not satisfied, the update scenario mode may be triggered.

As another example, a deep learning model may be trained, in advance, to determine which mode to trigger by providing the updated scenario information to the deep learning model and obtaining a determination of whether to trigger the update scenario mode and/or the reset scenario mode. In an embodiment, supervised training may be employed to train the deep learning model, and the deep learning model may be trained using training samples that may include multiple examples of scenario information that may be labeled with the triggered modes. Alternatively of additionally, unsupervised training may also be employed. For example, a reinforcement learning model may be employed, where the deep learning model may be trained by feedback reward signals and/or punishment signals. However, the present disclosure is not limited in this regard, and various other methods may be used to determine which mode to trigger.

In an embodiment, when the update scenario mode is triggered, at least one element description word that meets the requirements may be re-selected based on changes to the requirements, and/or the element image may be regenerated accordingly as the updated dynamic element image, in addition, at least one element description word may be re-selected based on the updated scenario information. Alternatively or additionally, the substantive content may remain unchanged and only format (e.g., non-substantive) adjustments may be made to the dynamic element image without regenerating the element image.

In an embodiment, all element description words of each preset element may be organized into a plurality of word groups in advance, each word group may be used to generate one element image, and the same element description word may be reused in different word groups as needed. When regenerating the element image, only one word group may need to be re-selected. Alternatively, the corresponding element image for each word group may be generated in advance, and when the element image of the preset element may need to be updated, only the element image corresponding to the one word group may need to be re-selected. However, the present disclosure is not limited thereto.

The scenario information may include at least one of a multimedia type, a user profile, camera sensor data, a playback progress, or a playback mode. By configuring scenario information, appropriate scenario information may be selected as needed, in practice, in order to reasonably describe the entire scenario, and potentially satisfy different description requirements in different situations.

For example, the multimedia type may include a multimedia set and an independent multimedia. The multimedia set type may indicate that the multimedia data contains a plurality of multimedia files, and the independent multimedia type may indicate that the multimedia data contains only one multimedia file. In an embodiment, viewer users may need to switch between different multimedia files of a multimedia set. In such a scenario, referring to the multimedia data of the multimedia set type, the element image related to each multimedia file may be determined as the dynamic element image, and the element image related to the entire multimedia set may be determined as the static element image, such that only the element image related each multimedia file may need to be updated when the user switches between the different multimedia files. Referring to the multimedia data of the independent multimedia type, static element images may be used more, which may provide reference for the determination of the dynamic and/or static element images.

In an embodiment, the update scenario mode may be triggered if the updated scenario information corresponds to the multimedia data of the multimedia set type switching the multimedia files, and the reset scenario mode may be triggered if the updated scenario information corresponds to a switch of the multimedia data.

In an embodiment, referring to the multimedia data of the multimedia set type, a relatively large number of the description words may be determined for the entire multimedia data, and thus, it is likely that different description words may be determined for different multimedia files of the multimedia set. As such, when initially generating the element images for a preset element that has a relatively close relationship with the multimedia file (e.g., the introduction text), the description words corresponding to the multimedia file that is currently localized may be selected as the element description words of the preset element to generate the corresponding element image.

The user profile may include at least one of a viewing preference, a gender, or an age. The user profile may reflect (indicate) the content that the user is interested in. Thus, when the scenario information includes the user profile, the dynamic and/or static element images may be determined individually in conjunction with the analysis of the user profile, and a reference may be provided for the update of the description image, which may improve the flexibility of the image generation. The user profile may be part of the user information used in the determination of the description words of the multimedia data, and as such, its use in such a determination may also be authorized by the user and/or authorized by the related parties.

In an embodiment, if it is determined, based on the user's viewing history, that the user has a wide range of hobbies and/or a variety of different preference styles, the description words may be generated for each of the different preference styles, and the preset elements related to these description words may all be determined as dynamic elements. In addition, the element description words used by the dynamic elements may be determined based on the preference style associated with the most recently viewed multimedia content by the user, and subsequently, the dynamic element images and the description image may be generated. As another example, if the user profile indicates that the style of the multimedia content recently viewed by the user has changed, and the scope of the change remains within the previously determined plurality of styles, the update scenario mode may be triggered to re-determine the element description words to be used according to the new style of the multimedia content and generate the corresponding updated dynamic element image. However, if the user profile indicates that the style of the multimedia content recently viewed by the user has changed beyond the previously determined plurality of styles, the reset scenario mode may be triggered.

The camera sensor data may include at least one of user identification, a viewing distance, background noise, or ambient light. The camera sensor may be configured to capture the actual viewing state of the user, and thus, may provide reference information for the determination and/or update of the dynamic and/or static element images. For example, the user identification may identify a particular user as the current viewing user, which may be used as a reference for determining the user information in operation S201, and the reset scenario mode may be triggered when the current viewing user is identified to be changed (e.g., a different user). The viewing distance may indicate the distance between the user and the electronic device, which may be taken as a basis for adjusting the text size in the description image. For example, a smaller text size may be used when a viewing distance is smaller (e.g., user is closer to the electronic device). Thus, when the scenario information includes the viewing distance, the preset elements (e.g., a title, an introduction text) containing text may be determined as dynamic elements, and the update scenario mode may be triggered, when the viewing distance is identified to be changed, in order to adjust the text size of the dynamic element images corresponding to these preset elements. Background noise and ambient light may also be included as references for generating and adjusting the description images as such factors may affect the viewing requirements of the user. It may be understood that the camera sensor data used herein, similarly to the user information, may also be information that is authorized for use by the user and/or all related parties.

The playback progress may indicate a stage in which the currently targeted multimedia content is located within the entire multimedia data, and since the entire multimedia data may contain a significant amount of content, the playback progress may relatively accurately represent the current specific content, thus providing a more targeted description. For example, the element image that introduces a particular playback progress may be determined as a dynamic element image, and the element image that introduces the entire multimedia data may be determined as a static element image. As another example, when the playback progress changes but has not yet ended, the update scenario mode may be triggered to switch to a different dynamic element image.

In an embodiment, referring to the multimedia data of the multimedia set type, a relatively large number of description words may be determined for the entire multimedia data, and thus, it is likely that different description words may be determined for different playback progresses. As such, when initially generating the element images for a preset element that has a relatively close relationship with the playback progress (e.g., the introduction text), the description words corresponding to the playback progress that is currently localized may be selected as the element description words of the preset element to generate the corresponding element image.

The playback mode may include at least one of a child mode, an elderly mode, a standard mode, or an office mode. When the electronic device is configured with different playback modes, the different playback modes, which may each reflect distinct viewing requirements, may also be used as references for determining the description image. For example, referring to the child mode, the use of the introduction text that is one preset element may be canceled. As another example, referring to the elderly mode, the number of words in the introduction text that is one preset element may be reduced and/or the text size of the introduction text and/or the title may be zoomed in. In addition, the different playback modes may also adopt different styles of background images. In an embodiment, when the scenario information includes the playback mode, in conjunction with the playback modes being supported by the electronic device, it may be possible to determine which preset elements may change when switching the playback modes, thereby determining the static elements and the dynamic elements, and triggering the update scenario mode when the playback mode changes.

In an embodiment, operation S202 may further include processing, using a large language model, the multimedia data and the user information to determine the description words of the multimedia data. By processing the multimedia data and the user information using the large language model, it may be possible to obtain description words that may not only be in accordance with the actual content of the multimedia data but may also be sufficiently matched with the viewing requirements of the user, which may potentially improve the effectiveness of the description words. For example, a multimodal large language model that may be capable of processing the multimedia data may be used. In an embodiment, the multimedia data and the user information may be input into the large language model simultaneously to directly obtain the description words. Alternatively or additionally, the multimedia data may be input into the large language model separately to obtain objective description words that may not related to the user, and subsequently, the objective description words and the user information may be input into the large language model together in order to obtain the description words specific to the user. For example, the multimedia data (or corresponding objective description words) and the user information may be combined using prompts so as to provide to the large language model, with the help of detailed prompts, clear principles and directions for the generation of the description words. For example, a prompt similar to “Please extract the description words of the television series that will be input next from the personal perspective of user A, whose information is as follows: . . . ”, may be provided to the large language model, where “. . . ” may represent the user information. The video data of the corresponding television series may also be provided to the large language model.

Alternatively or additionally, operation S202 may further include extracting text data (including, for example, data directly in the form of text, data obtained by performing speech recognition on the audio, or caption data extracted from the image) in the multimedia data using a related natural language processing technique, filtering out words from the text data that may conform to the user information using semantic analysis, and using the filtered out words as the description words for generating the description image.

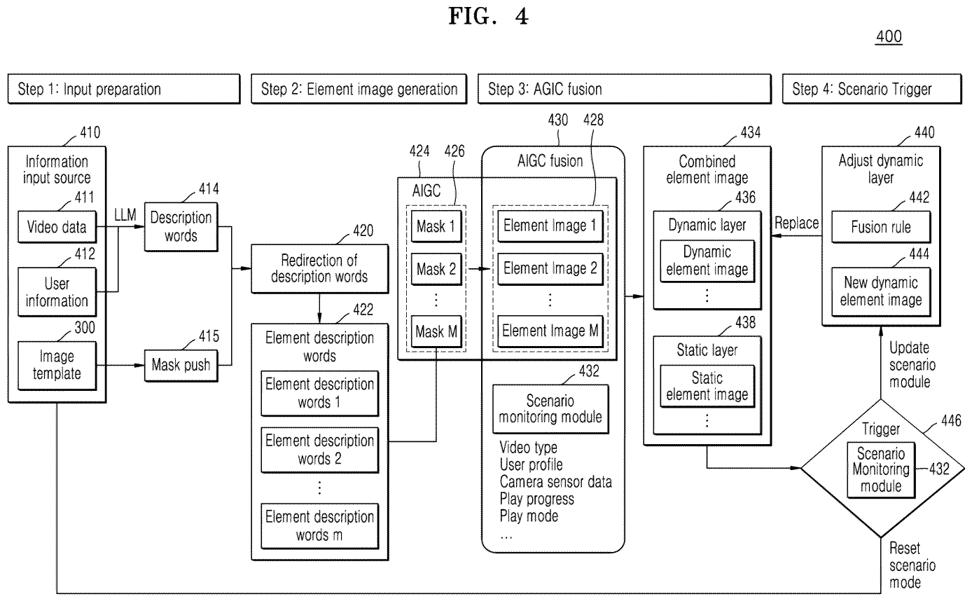

An embodiment that may be used to generate the description image of the video data, which may be applied to a video detail page, a TV screensaver page, a page of video recommendation widgets, or the like is described with reference to FIG. 4. Although FIG. 4 describes, by way of non-limiting example, some processing flows such as, but not limited to, flows for generating the description words, generating the element images, or the like, the present disclosure is not limited in this regard. For example, processing flows described therein may also be implemented for adopting other processing flows in the field. As another example, various other processing flows may be implemented for performing similar functions (e.g., generating the description words, generating the element images, or the like) without departing from the scope of the present disclosure.

Referring to FIG. 4, an image generating method, according to an embodiment, is illustrated. As shown in FIG. 4, the image generating method 400 may include four (4) steps (e.g., Step 1 to Step 4) as described below.

### Step 1: Input Preparation

In Step 1, the image generating method 400 may include obtaining the description words (corresponding to operations S201 and S202), and a mask that may be used to represent the element display region or the image template 300) (corresponding to operation S203).

Referring to Step 1, the image generating method 400 may be provided, from an information input source 410 (e.g., a multimedia server, a user management server, or the like), video data 411 (e.g., video image frames, audio, posters, dialog lines, and/or other content), user information 413, and the image template 300.

The image generating method 400 may provide the video data 411 and the user information 412 to a large language model (LLM) for analysis, which may output a relatively large number of phrases as the description words 414.

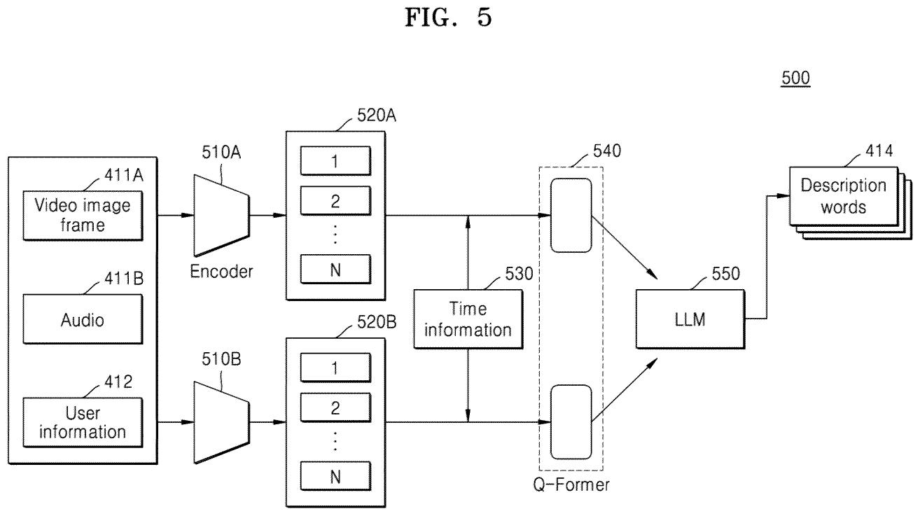

For example, as shown in FIG. 5, the video image frames 411A, the audio 411B, and the user information 412 may be input into encoders (e.g., a first encoder 510A, a second encoder 510B) to obtain a plurality of N-dimensional vectors (e.g., a first encoded vector 520A, and a encoded second vector 520B, hereinafter generally referred to as “520”, where N is a positive integer greater than zero (0)). Although FIG. 5 illustrates two (2) encoding paths, the present disclosure is not limited in this regard. For example, in practice, the flowchart 500 may include more encoding paths. For example, each piece of information may be encoded by a corresponding encoder. Thereafter, the obtained encoded vectors (or embedding vectors) 520 may be input into the feature extractor Q-Former 540, which may be configured to extract feature vectors suitable for processing by the large language model (LLM) 550. In addition, when inputting the encoded vectors 520, due to the relatively large amount of information in the video image frames and the audio, the encoded vectors 520 may be input in segments, and the encoded vectors 520 of the video image frames and the audio frames that may temporally correspond to each other may be input simultaneously, by the time information module 530, In this manner, the LLM 550 may process the temporal information therein, and to output the description words 414.

Returning to FIG. 4, the image generating method 400 may decompose the description image to be generated, based on the plurality of preset elements in the image template 300, into a plurality of masks 415, each of which may correspond to one preset element. The plurality of masks 415 may be pushed to a subsequent step (e.g., Step 2) to perform the redirection of the description words 414.

The separate processing of each preset element may provide for the separate control of each variable element, which may reduce randomness in the generation of the description image and may result in a relatively stable and/or accurate image expression, when compared to related image generation methods. For example, subsequent changes to the scenario, may only trigger regeneration of the element images corresponding to some of the preset elements and the layers composed of these element images, without affecting the other remaining layers of the entire description image, thus maintaining the stability of the description image and the page to which the description image is applied. In addition, the separate generation of the element image corresponding to each preset element may provide a relatively more precise generation requirement for the key information in the description image.

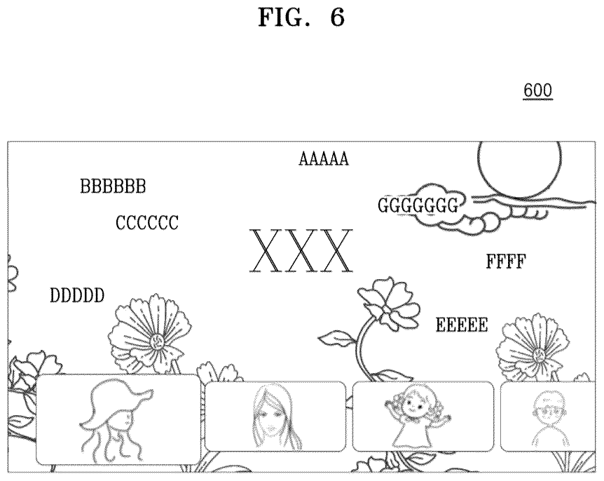

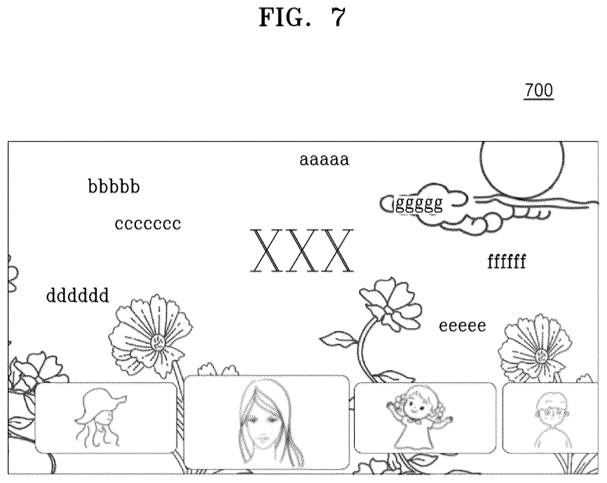

For example, FIGS. 6 and 7 respectively illustrate description images for a first episode and a second episode of a television series XXX, according to an embodiment. Referring to FIG. 6, a first description image 600 for the first episode of the television series XXX is depicted. As shown in FIG. 6, the first description image 600 may include a first plurality of introduction text of the first episode (e.g., “AAAAA”, “BBBBBB”, “CCCCCC”, “DDDDD”, “EEEEE”, “FFFF”, and “GGGGGGG”). Referring to FIG. 7, a second description image 700 for the second episode of the television series XXX is depicted. As shown in FIG. F, the second description image 700 may include a second plurality of introduction text of the second episode (e.g., “aaaaa”, “bbbbbb”, “cccccc”, “ddddd”, “eeeee”, “ffff”, and “ggggggg”).

In an embodiment, when the user moves the selection cursor from the first episode to the second episode, only the introduction text of the video may need to be changed (e.g., from the first plurality of introduction text of the first episode to the second plurality of introduction text of the second episode). For example, if the image template 300 is not used, then the entire description image (e.g., the second description image 700) may need to be regenerated, and consequently, excessive randomness may be introduced between the first description image 600 and the second description image 700. For example, regenerating the entire description image may cause the position and/or style of the background image and/or the title (e.g., the name of the television series) to be changed. However, if the image template 300 is used, for example, only the introduction text may need to be changed, and the updated description image (e.g., the second description image 700) may be obtained as shown in FIG. 7, which may maintain the stability of the description image as well as the page.

### Step 2: Element Image Generation

In Step 2, the image generating method 400 may include obtaining a plurality of element description words 422 of each preset element, and a plurality of element images 428 of each preset element.

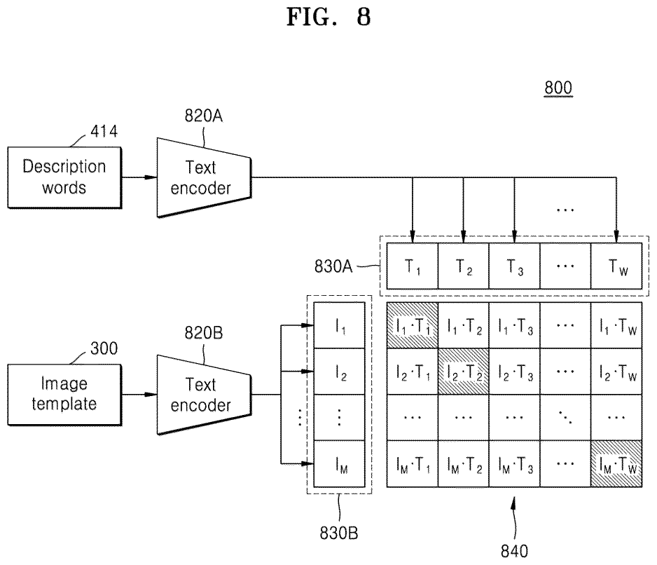

Referring to Step 2, the image generating method 400 may obtain the plurality of element description words 422 (e.g., first element description words 1, second element description words 2, to m-th element description words m, where m is a positive integer greater than zero (0)) performing redirection 420 of the description words 414 determined by Step 1 of the image generating method 400, based on the mask 415 pushed by Step 1. For example, the performing of the redirection 420 of the description words 414 may be described with reference to FIG. 8.

FIG. 8 illustrates a schematic flowchart of a redirection of description words, according to an embodiment of the present disclosure. Referring to FIG. 8, the flowchart 800 may perform the redirection 420 of the description words 414, according to the image generating method 400. In describing FIG. 8, it may be assumed that the number of description words may be W, where W is a positive integer greater than one (1), and that the image template 300 includes M preset elements, where M is a positive integer greater than zero (0). Each preset element may include element configuration information that may include text of the preset element (e.g., the title, the introduction text, the background image, and other element names) and may also include the description of the form of the mask of the preset element (e.g., the position and size of the filled region, or the like).

As shown in FIG. 8, each description word of the W description words 414 may be encoded separately by a first text encoder 820A to obtain W encoded vectors 830A (e.g., a first encoded vector T₁, a second encoded vector T₂, a third encoded vector T₃, to a W-th encoded vector T_{W}) corresponding to the description words 414. In addition, the text of the element configuration information of each preset element may be encoded separately by a second text encoder 820B to obtain the M encoded vectors 830B (e.g., a first encoded vector I₁, a second encoded vector I₂, to an M-th encoded vector I_{M}) corresponding to the preset elements of the image template 300.

The dot products may be calculated one by one corresponding to the encoded vector 830B of each preset element and the encoded vector 830A of each description word. As shown in FIG. 8, each dot product in a matrix 840 may represent the correlation between the corresponding description word and the preset element. In an embodiment, a number of dot products, represented by the hashed cells in the matrix 840, may be filtered out as the redirection results according to the value of each dot product. For example, I₁·T₁ may indicate that the first description word is used as the element description word of the first preset element, I₂·T₂ may indicate that the second description word is used as the element description word of the second preset element, and I_{M}·T_{W} may indicate that the W-th description word is used as the element description word of the M-th preset element. However, these labels herein are only schematic and may not represent the actual redirection results. For example, the number W of description words 414 may be significantly larger than the number M of preset elements, and as such, each preset element may be capable of obtaining a plurality of element description words 414.

Specific rules for determining the element description words may be set as required, for example, for the matrix shown in FIG. 8, a comparison may be performed column-by-column, and the cell (row) with the largest value in the same column may be labeled as a redirection result, consequently, each description word may only be redirected to one preset element. Alternatively or additionally, a threshold may also be set, and dot products larger (greater) than the threshold may be labeled as redirection results, and as a result, the number of preset elements to which each description word is redirected may be uncertain. In addition, it may further be required, when no dot product is larger than the threshold in the same column, the dot product with the largest value may labeled as a redirection result in order to ensure that each description word may be redirected.

Returning to FIG. 4, the redirection 420 may generate the plurality of element description words 422, and each piece of element description words may have the corresponding preset element. That is, even if two pieces of element description words originate from the same piece of description words, the two pieces of element description words may be regarded as different pieces of element description words for generating the element images of different preset elements.

The image generating method 400 may generate the plurality of element images 428 (e.g., a first element image 1, a second element image 2, to an M-th element image M) based on at least one element description word 422 of each preset element and a corresponding mask 426 (e.g., a first mask 1, a second mask 2, to an M-th mask M), using AIGC function 424.

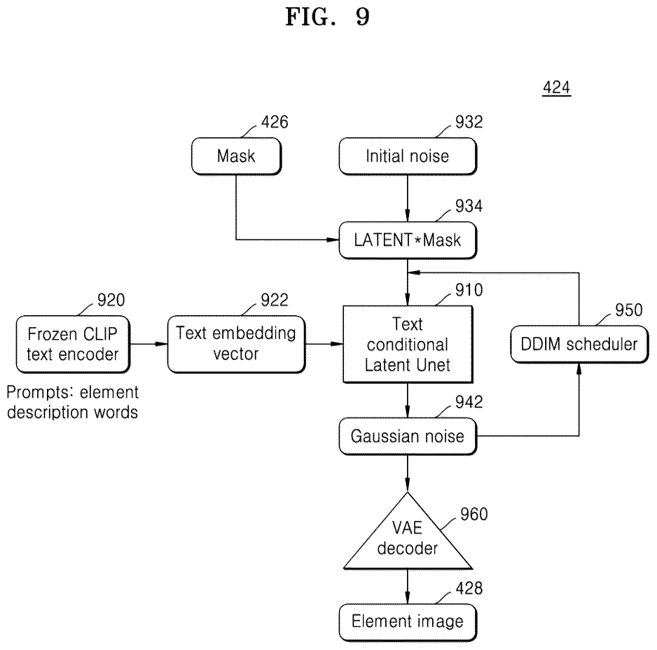

For example, as shown in FIG. 9, a flowchart 900 for generating an element image according to the AIGC function 424 may be implemented using the text conditional latent Unet 910, which may refer to a generation model (or a generative model) that may combine text conditions and a U-Net architecture, and may be used for image generation, image restoration, and/or other image-related tasks. However, the present disclosure is not limited in this regard, and other model(s) or neural network(s) may be used to implement the AIGC function 424 without departing from the scope of the present disclosure. In an embodiment, the AIGC function 424 may utilize other convolutional neural network (CNN) for image generation, image restoration, and/or other image-related tasks.

Referring to FIG. 9, the text conditional latent Unet 910 may have two (2) inputs. As a first input, text embedding vectors 922 may be obtained by encoding the element description words 422 using a frozen contrastive language-image pre-training (CLIP) text encoder, for example. As a second input, an initial element image may be obtained based on the mask 426 and initial noise 932 (adding noise), where the noise may represent the complete image for the entire display region, and the initial noise 932 may represent the initial value of the complete image. The initial noise 932 may be clipped based on the mask 426, and only the part of the filled region (e.g., the transparent region) defined by the mask 426 may be retained, resulting in the initial element image 934, which may be expressed as Latent×Mask, which may be a product of a hidden variable (Latent) corresponding to the initial noise 932 and the mask 426.

In an embodiment, the input to the text conditional latent Unet 910 may be the coded vector of the initial element image rather than the image data. Based on the text embedding vector 922 and initial element image 934, the text conditional latent Unet 910 may output a predicted noise 942 (e.g., a Gaussian noise), and provide the predicted noise 942 to a denoising diffusion implicit model (DDIM) scheduler 950, which may be a scheduler for the text conditional latent Unet 910. The DDIM scheduler 950 may be applied to the training procedure and the inference procedure of the text conditional latent Unet 910, and may improve the generation efficiency and quality of the text conditional latent Unet 910 by optimizing the sampling process. The processed noise may be returned to the text conditional latent Unet 910 by the DDIM schedule 950, and the text conditional latent Unet 910 may perform an iterative calculation of the predicted noise 942. When an end condition is reached (e.g., a predetermined number of iterations is reached), the element image 428 corresponding to the element description words 422 and the mask 426 may be obtained by decoding of the variational autoencoder (VAE) decoder) 960.

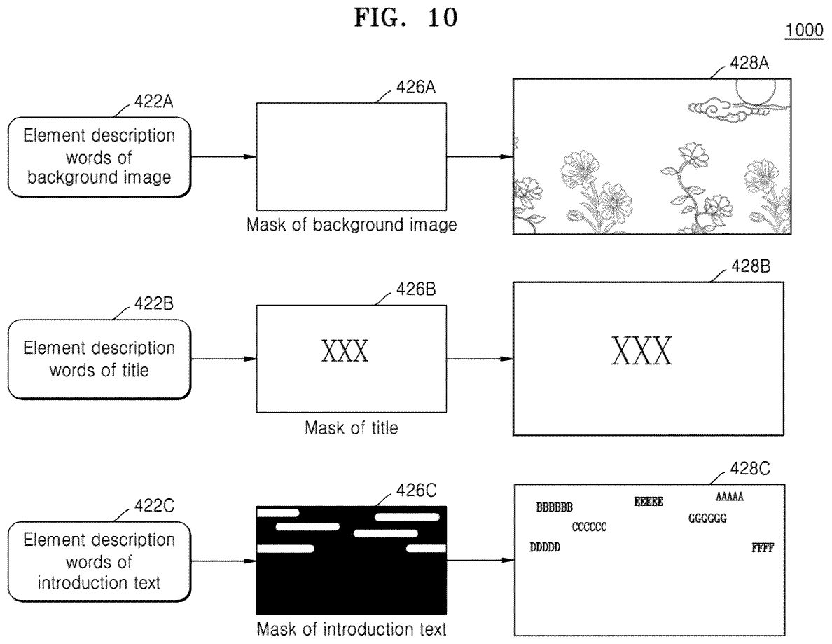

Referring to FIGS. 6, 9, and 10 together, the flowchart 900 shown in FIG. 9 may be used to generate the element image of the background image 428A utilizing the element description words 422A and the mask 426A of the background image, generate the element image of the title 428B by using the element description words 422B and the mask 426B of the title, and generate the element image of the introduction text 428C by using the element description words 422C and the mask 426C of the introduction text.

### Step 3: AIGC Fusion

In Step 3, the image generating method 400 may include performing AIGC fusion on the plurality of element images 428 using an AIGC fusion module 430 and combine the fused element images into a dynamic layer 436 and a static layer 438.

As shown in FIG. 4, a scenario monitoring module 432 may generate one or more fusion rules according to scenario information. The one or more fusion rules may specify whether an element image of the plurality of element images 428 is at least one of a dynamic element image or a static element image. The scenario information may include a plurality of scenario texts, which may include, for example, a video type, a user profile, camera sensor data, a playback progress, a playback mode, or the like. The video type may include at least one of a video set or an independent video, where the video set may contain a plurality of video files (e.g., a television series, a periodically updated variety show, a documentary series, or the like), and the independent video may contain a single video file (e.g., a movie, a sporting event, an awards show, or the like). The user profile may include information for distinguishing between different viewers, including, for example, a viewing preference, a gender, an age, or the like. The camera sensor data may include user identification, a viewing distance, background noise, ambient light, or the like. The playback progress may indicate relevant plots and/or scenes of the single video, and for the video set, the playback progress may indicate main plots of the video file that is currently set to be played from the video set. The playback mode may include at least one of a child mode, an elderly mode, a standard mode, or an office mode.

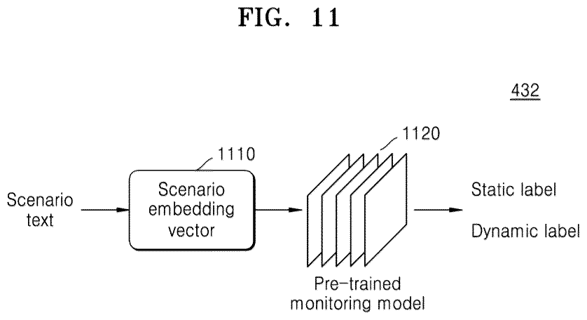

As shown in FIG. 11, the scenario monitoring module 432 may encode the plurality of scenario texts into scenario embedding vectors 1110, and provide the encoded scenario texts to a pre-trained monitoring model 1120. The pre-trained monitoring model 1120 may determine a fusion rule. That is, the pre-trained monitoring model 1120 may determine whether each element image of plurality of element images 428 is a static element image or a dynamic element image.

For example, if the pre-trained monitoring model 1120 determines that an element image 428 is a static element image, the pre-trained monitoring model 1120 may output a first value corresponding to a static label (e.g., “0”, zero, or a low logic level). Alternatively, if the pre-trained monitoring model 1120 determines that an element image 428 is a dynamic element image, the pre-trained monitoring model 1120 may output a second value corresponding to a dynamic label (e.g., “1”, one, or a high logic level).

However, the present disclosure is not limited in this regard, and the pre-trained monitoring model 1120 may output other or different values to indicate whether an element image is a static or a dynamic element image. In addition, the present disclosure is not limited as to the pre-trained monitoring model 1120. That is, the type of model used for the pre-trained monitoring model 1120 is not restricted. The training samples used to train the pre-trained monitoring model 1120 may contain the scenario information and labels for a number of sample element images.

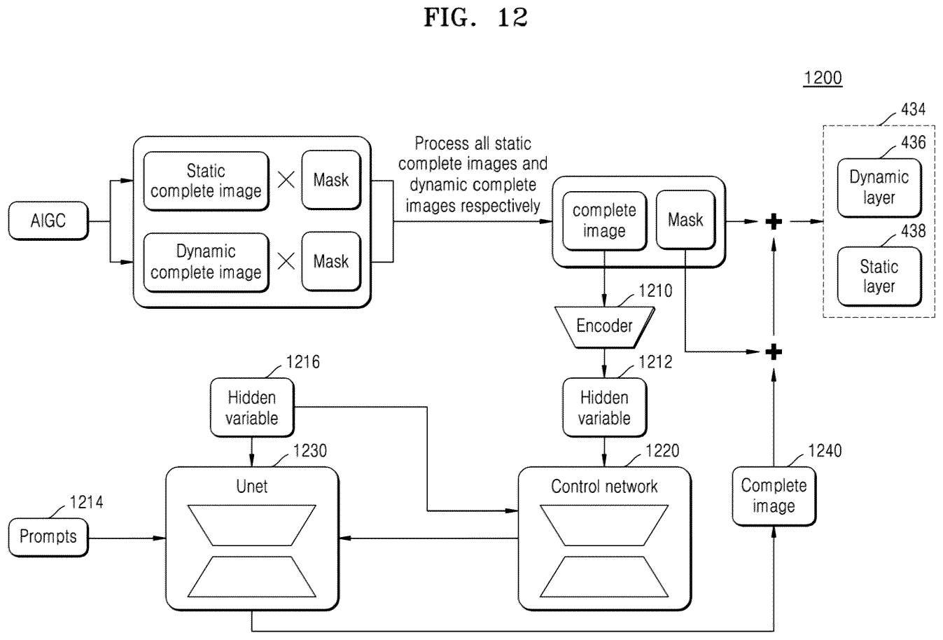

Returning to FIG. 4, the plurality of element images 428 may be fused into the description image 434 (or combined element image). For example, as shown in FIG. 12, a flowchart 1200 for fusing the plurality of element images 428 generated by the AIGC function 424, by combining the dynamic complete image and/or the static complete image with the corresponding masks. The dynamic complete image may refer to the complete image outputted by the VAE decoder 960 corresponding to the dynamic element image. Similarly, the static complete image may refer to the complete image outputted by the VAE decoder 960 corresponding to the static element image.

In addition, when fusing the plurality of element images 428 may fine-tune each element image in order to ensure the fusion effect and avoid simply overlapping the respective element images in order. For example, if the display regions of different element images overlap, the corresponding element image may be fine-tuned in order to avoid an indistinct (unclear) display in the overlapped region after the performing the fusion. That is, in such an example, the fine-tuning may include moving positions of partial images, and/or adjusting the image color of the overlapped regions. As shown in FIG. 12, the fine tuning may be performed by providing the dynamic complete image and/or the static complete image to an encoder first to obtain a first hidden variable 1212, and the first hidden variable 1212 and a second hidden variable 1216 may be provided to a control network (Controlnet) 1220 that may be used to adjust the specific content of the complete image. For example the Controlnet 1220 may perform adjustments that may not be suitable adjusting the text of the complete image. For adjustments that may be performed by adjusting the text of the complete image, prompts 1214 and the second hidden variable 1216 may be provided to a Unet network 1230, so that the complete image may be adjusted according to the prompts 1214. The corrected complete image 1240 obtained after the adjustments may be combined with the corresponding mask to obtain the adjusted element image 434.

That is, the adjustment for the element image may be understood as the adjustment of the complete image. In addition, the position of the element display region (e.g., the position of the filled region (the transparent region) of the mask), may also be moved. Thereafter, the respective adjusted dynamic element images may be overlaid together and fused into one dynamic layer 436, and respective adjusted static element images may be overlaid together and fused into one static layer 438. Finally, the dynamic layer and the static layer are merged together as the description image 434 of the video data. In this manner, merging may maintain the independence of the dynamic layer 436 and may provide flexibility of regeneration of the dynamic layer 436.

Taking the video detail page of a television series as an example, assuming that the image template 300 shown in FIG. 3 is used and the scenario information only includes the video type, since the current television series belongs to a video set, the title 310 and the background image 330 may be determined as the static elements, the introduction text 320 may be determined as the dynamic element, and the element image of the title and the element image of the background image may be used as the static element images to be merged into the static layer, and the element image of the introduction text of current episode (e.g., the first episode shown in FIG. 6) may be as the dynamic element image to generate the dynamic layer.

### Step 4: Scenario Trigger

Step 4 of the image generating method 400 may be implemented by a trigger 446 in conjunction with the scenario monitoring module 432. When the updated scenario information is received, the updated scenario information may be processed by the scenario monitoring module 432 to obtain a new fusion rule 442. If the fusion rule is changed and such change may be realized by modifying the dynamic layer 436 (e.g., regenerating and/or adjusting one or more dynamic element images), the update scenario mode may be triggered to re-determine, based on the new fusion rule 442, at least one element description word from all the element description words of a certain dynamic element. Accordingly, a new element image 444 of the dynamic element may be generated and/or the current one or more dynamic element images may be fine-tuned as a new dynamic element image 444. The new dynamic element image 444 may be used to replace the corresponding dynamic element image in the current dynamic layer 436 to regenerate the dynamic layer 436 as well as the description image 434. If the fusion rule is changed and such change may not be realized by modifying the dynamic layer, and the entire description image needs to be regenerated, the reset scenario mode may be triggered and the image generating method 400 may return to Step 1 again.

Returning to the description image 600 of the first episode of the television series XXX as an example, if the user changes the specific episode under the current television series (e.g., from the first episode to the second episode), the introduction text of the video may change due to the episode switching, which may trigger the update scenario mode to update the fusion rule to re-extract the element description words related to the second episode from among the element description words of the introduction text. Accordingly, the element image corresponding to the second episode may be generated to regenerate the dynamic layer 436, and the dynamic layer 436 may be merged together with the original static layer 438 to obtain the description image 700 of the second episode of the television series, as shown in FIG. 7. If the user switches to another television series, the reset scenario mode may be triggered, and the process flow 400 may be re-executed based on the newly switched television series to generate a new description image.

As discussed above, through content parsing (e.g., LLM) of a video, in conjunction with scenario requirements (e.g., user information, an image template, scenario information, or the like), the redirection of the video parsing content (e.g., the description words) and the recharacterization of the preset elements in the image template (e.g., determined as the dynamic element or the static element) may be implemented. The redirection of the video parsing content may determine the generation of the content of the description image, and the recharacterization of the preset elements may determine whether the layer is relatively dynamic or static, which is, in principle, a method of controlling variables, with the aim of generating images that meet quality requirements and potentially reduce the randomness of the AIGC generated objects. That is, according to aspects of the present disclosure, the accuracy and/or stability of the AIGC generated objects may be ensured while their flexibility may be maintained.

Several more examples of applying the image generating method, according to aspects of the present disclosure, to generate and/or update the description image of the video are described below.

### Example One

As a first example, aspects of the present disclosure may be applied to a video detail page. That is, the image template 300 may be used, and the scenario information may include at least the video type, the user identification in the camera sensor data, and the playback progress. The video on the current page may correspond to a movie named “XX”, which may contain science fiction elements. Although the video type to which the movie belongs may be the independent video type, the playback progress may affect the introduction text, so the title 310 and the background image 330 may be determined as the static elements, and the introduction text 320 may be determined as the dynamic element.

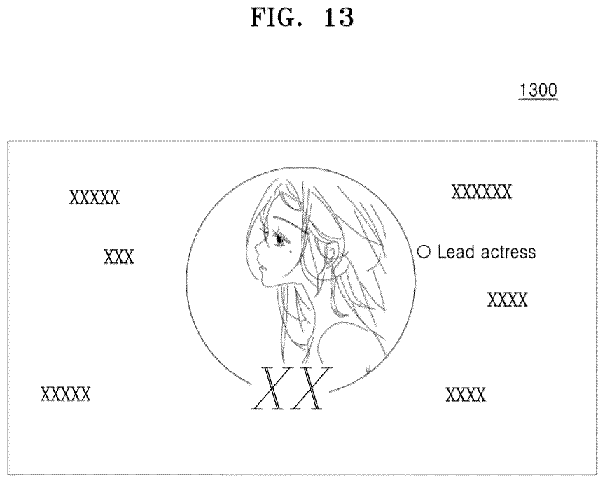

For an identified user A, the user information thereof may contain the user profile, which may indicate that the user A is female, has preference for romantic movies, and the current playback progress may indicate that the movie has not been played yet. Based on the user information and the video data of the movie, the element image 330 of the background image may contain a female portrait, the element image (e.g., 322A to 332E) of the introduction text may contain descriptive words such as “lead actress” and “xxx”, and the element image 312 of the movie title may be generated, and the resulting description image may be similar to the description image 1300 shown in FIG. 13.

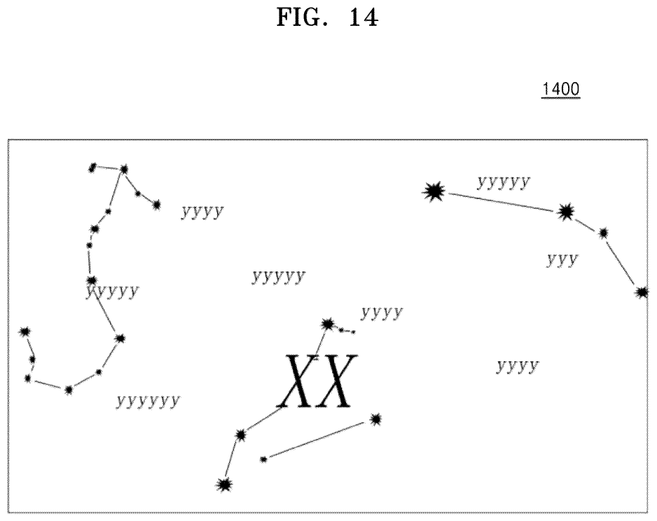

When the camera sensor data identifies that the current user is switched to user B, the reset scenario mode may be triggered. In an embodiment, the user information of user B may indicate that user B is male, a technology geek, and has a preference for science fiction movies. Based on the user information of user B and the video data of the movie, the element image of the background image may contain a starry sky, the element image of the introduction text may contain a number of descriptive words “yyyy” or the like related to science fiction and/or technology, and the element image of the movie title may be regenerated. The resulting updated description image may be similar to the description image 1400 as shown in FIG. 14.

### Example Two

As a second example, aspects of the present disclosure may be applied to a video detail page. That is, the image template 300 may be used, and the scenario information may include at least the video type and the viewing distance in the camera sensor data. The video on the current page may continue to correspond to the movie named “XX”, described above with reference to the first example. Since the video type to which the movie belongs is an independent video, the actual content of all three preset elements may not change. However, since the scenario information includes the viewing distance, the text size may need to be adjusted due to the change in the viewing distance, and thus, the title and the introduction text may be determined as the dynamic elements, and the background image may be determined as the static element.

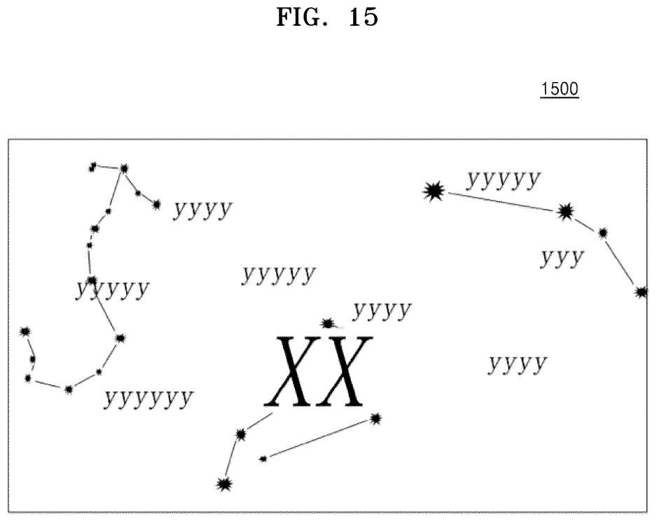

For the aforementioned user B, the description image 1400 may be generated as shown in FIG. 14. When the viewing distance is increased, the update scenario mode may be triggered, and the text size in the element images of the title and introduction text may be increased to generate an updated description image that may be similar to the description image 1500 shown in FIG. 15.

### Example Three

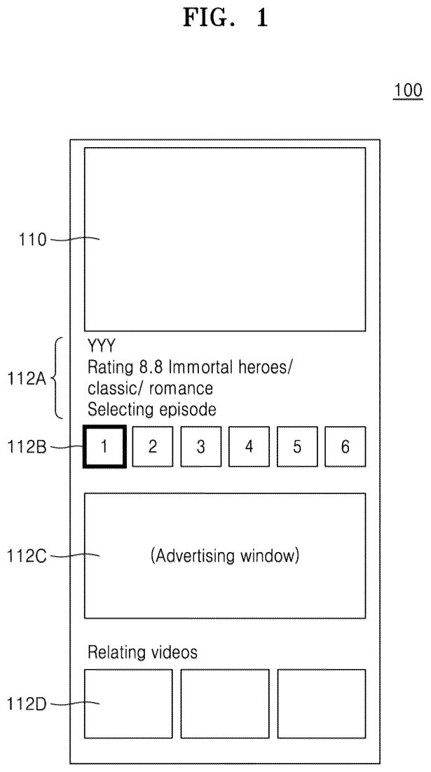

As a third example, aspects of the present disclosure may be applied to a video detail page of a cell phone. The existing video detail page of the television series for the cell phone may be similar to the screen 100 shown in FIG. 1, with only a simple arrangement of the video window (e.g., the rectangular window 110 at the top of the screen 100), the title (e.g., YYY in the first widget 112A), the episode list 112B, the advertising window 112C, and the related videos 112D. In the example, an image template matching the video detail page of the cell phone screen 100 may be used, which main include the preset element of main actors for replacing the existing advertising window 112C, in addition to three preset elements of the title, the introduction text, and the background image. In the example, the title, the background image, and the main actors may be set as the static elements, and the introduction text may be set as the dynamic element, in advance, which changes triggered by the switching of the episodes.

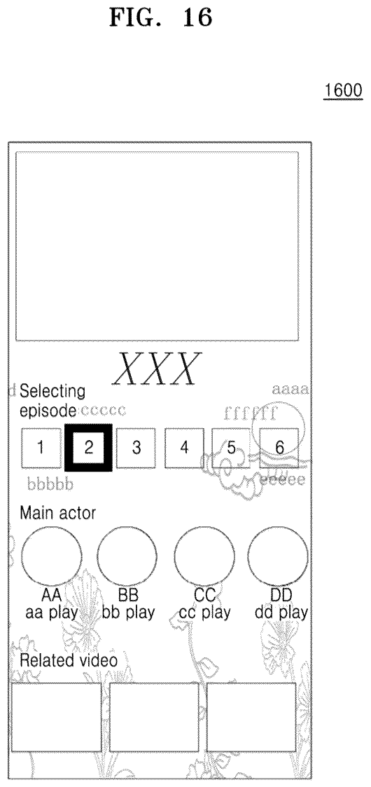

Alternatively or additionally, the main actors may also be set as a dynamic element that displays the actors of the characters appearing in the current episode (and/or a scene of the current episode) when the episode is switched. The image template may also be configured with the masks corresponding to respective preset elements to layout the element images of these preset elements, while the original title and the advertising window in FIG. 1 are adaptively deleted. The new video detail page 1600 as shown in FIG. 16 may be generated as the video detail page of the television series XXX described with reference to FIGS. 6 and 7, in the cell phone.

### Example Four

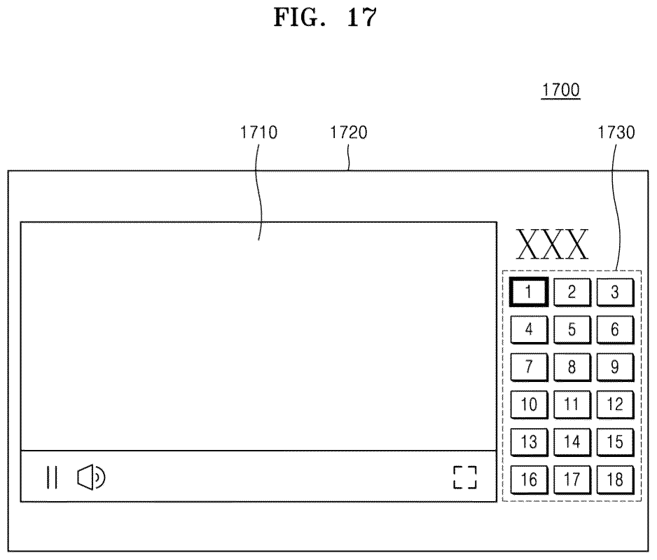

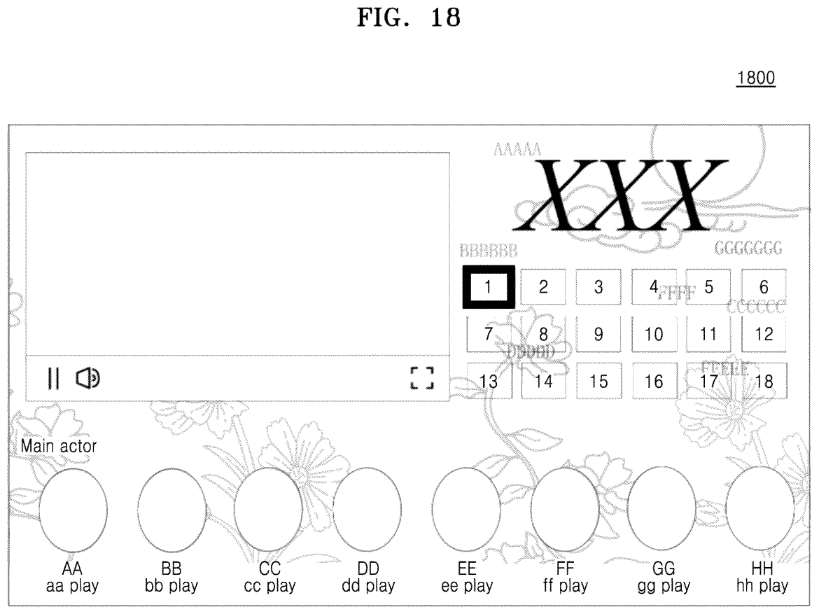

As a fourth example, aspects of the present disclosure may be to a video detail page of a tablet computer. An existing video detail page 1700 of the television series for the tablet computer is shown in FIG. 17, with only a simple arrangement of the video window 1710, the title 1720, and the episode list 1730. In this example, an image template matching the video detail page of the tablet computer may be used, which, as in Example Three, may include four (4) preset elements (e.g., the title, the introduction text, the background image, and the main actors). In this example, the title, the background image, and the main actors may be set as the static elements and the introduction text may be set as the dynamic element in advance. The image template may also be configured with the masks corresponding to respective preset elements, and the masks may different from the masks of Example Three to be adapted to the screen of the tablet computer, which lays out the element images of these preset elements, while the original title 1720 is adaptively deleted, and the size and layout position of the video window 1710 and the episode list 1730 are adaptively adjusted. The new video detail page 1800 as shown in FIG. 18 may be generated as the video detail page of the television series XXX, as described above with reference to FIGS. 6 and 7, in the tablet computer.

### Example Five

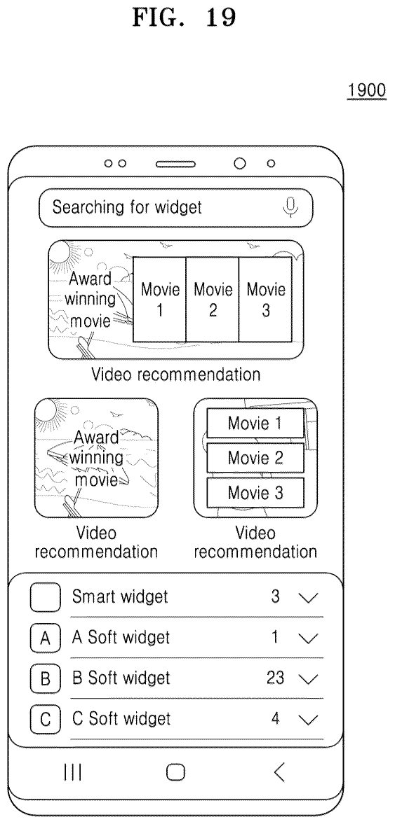

As a fifth example, aspects of the present disclosure may be applied to the video recommendation widgets of the desktop of a cell phone. A cell phone may have one or more desktop widgets, which may include video recommendation widgets. For example, as shown in FIG. 19, a description image 1900, of the video recommendation widgets of the desktop of the cell phone may be generated based on a number of recommended videos and/or user-preferred styles. A variety of different image templates may be utilized to generate different layouts, and different layouts of the description images may be obtained for the user to choose as requirements. As shown in FIG. 19, the image templates used for generating these description images, whose preset elements may all include the background image, may include at least one of a recommendation reason and a video poster.

Although several examples of application of aspects of the present disclosure are discussed above, the present disclosure is not limited in this regard. That is, aspects of the present disclosure may be applied to other examples without departing from the scope of the present disclosure. For example, one or more of the description images described above may also be applied to a TV screensaver, and/or other image templates may be selected based on the size of the TV screensaver.

The image generating method, according to embodiments of the present disclosure, may automatically generate utilizing the content of the video as the input source, a high-quality video detail page based on an image template and user viewing scenario detection, without manual labor. The use of a layered processing method (e.g., the static and dynamic layers), which, in principle, is a controlled variable method, aims to potentially reduce the randomness of the AIGC generated product. That is, the image generating method described herein may ensure the accuracy and/or stability of the description images generated by AIGC while maintaining their flexibility. In particular, an LLM technique may be used to analyze the video content and/or generate the description words as the content input source for AIGC. The description words of the video may be redirected, in conjunction with the user information, the image template, or the like, to generate the element images for the different preset elements. The element images may be fused into the dynamic and static layers according to the scenario monitoring. The dynamic layers may be regenerated separately when the scenario changes. The independent generation process of the dynamic layers may ensure the flexibility of the page content and the static layers may ensure the stability of the page. The image generating method may be applied to any page self-generated scenario with an image template and a certain content theme.

Advantageously, the image generating method, according to embodiments, may reduce the randomness of the AIGC generation. That is, the description words generated by LLM based on the video may ensure the objectivity and richness of the input sources. The layered image generation may improve the accuracy, flexibility, and stability of the visual representation of the page, in which the static layer may ensure the stability of the page and the independent generation process of the dynamic layer may ensure the flexibility of the page content. Furthermore, aspects of the present disclosure may satisfy a massive scenario adaptation. By using different image templates, the image generating method may be applied to a variety of devices that may need to generate the description images. In addition, the image generating method may generate description images of relatively high quality and relatively low operational costs. That is, the image generating method may provide video detail pages with improved visual effects and content delivery, when compared to related video detail pages. The image generating method may ensure an objective match between the video content and the style of the generated image, while potentially achieving high visual effects, and generating the description image with relatively low operational costs, when compared to related video detail pages containing visual effects and produced by manual image manipulation.

Furthermore, aspects of the present disclosure provide an image generating method that provides users with a customized and smooth user experience. For example, the built-in video detail page of a TV may provide a relatively more streamlined TV viewing experience compared to a related TV detail page that may require jumping to a third-party application to open the relevant video detail page. In addition, user preferences, TV viewing environment, or the like may affect the presentation of the page and the page may be adjusted to optimize a display state of the page.

FIG. 20 is a block diagram of an image generating apparatus, according to an embodiment of the present disclosure. The image generating apparatus 2000 may be used to generate a description image of multimedia data. Referring to FIG. 20, the apparatus may include a receiving unit 2001, a description unit 2002, and a generating unit 2003.

The receiving unit 2001 may be configured to receive the multimedia data and user information of a current user, wherein the current user is a viewer user of the multimedia data. The receiving unit 2001 may be configured to receive one or more image templates (e.g., the image template 300 illustrated in FIG. 3).

The description unit 2002 may be configured to determine description words of the multimedia data according to the multimedia data and the user information.

The generating unit 2003 may be configured to generate the description image of the multimedia data according to the description words.

Alternatively or additionally, the generating unit 2003 may be further configured to receive an image template including a plurality of preset elements, determine element description words for each preset element of the plurality of preset elements based on the description words, generate an element image of each preset element according to the element description words for each preset element, and generate the description image of the multimedia data according to the element image of each preset element.

Alternatively or additionally, the generating unit 2003 may be further configured to determine, from element images of the plurality of preset elements, dynamic element images and static element images, fuse the dynamic element images to a dynamic layer and the static element images to a static layer, respectively, and merging the dynamic layer and the static layer to the description image of the multimedia data, wherein the dynamic layer is capable of being regenerated.

Alternatively or additionally, the generating unit 2003 may be further configured to acquire scenario information, wherein the scenario information is related to the current user and a viewing behavior of the current user for the multimedia data, determine, according to the scenario information, the dynamic element images and the static element images from among the element images of the plurality of preset elements, wherein the dynamic layer is capable of being regenerated when the scenario information changes.

Alternatively or additionally, the image generating apparatus may further include a triggering unit and an updating unit. The triggering unit may be configured to determine, in response to receiving updated scenario information, whether to trigger an update scenario mode or a reset scenario mode according to the updated scenario information. The updating unit may be configured to, in the case of determining to trigger the update scenario mode, adjust, according to the updated scenario information, the dynamic element images to obtain updated dynamic element images, fusing the updated dynamic element images to an updated dynamic layer, and merging the updated dynamic layer and the static layer to an updated description image of the multimedia data.

The receiving unit 2001, the description unit 2002, and the generating unit 2003 may be further configured to, in the case of determining to trigger the reset scenario mode, re-execute respective operations. That is, the receiving unit 2001 may re-execute the receiving of the multimedia data and the user information of the current user, the description unit 2002 may re-execute the determining of the description words of the multimedia data according to the multimedia data and the user information, and the generating unit 2003 may re-execute the generating of the description image of the multimedia data according to the description words.

Alternatively or additionally, the scenario information may include at least one of a multimedia type, a user profile, camera sensor data, a playback progress, and a playback mode. The multimedia type may include a multimedia set and an independent multimedia. The multimedia set may represent that the multimedia data contains a plurality of multimedia files. The independent multimedia may represent that the multimedia data contains only one multimedia file. The user profile may include at least one of a viewing preference, a gender, or an age. The camera sensor data may include at least one of user identification, a viewing distance, background noise, or ambient light. The playback mode may include at least one of a child mode, an elderly mode, a standard mode, or an office mode.

Alternatively or additionally, each preset element of the plurality of preset elements may include element configuration information. The element configuration information may include an element name and an element display region which may be used to represent a display region covered by the corresponding element image in the entire description image. The generating unit 2003 may be further configured to generate a complete image of each preset element according to the element description words and the element configuration information of each preset element, wherein a size of the complete image matches a size of the description image, generate the element image of each preset element based on the complete image and the element display region of each preset element.

Alternatively or additionally, the generating unit 2003 may be further configured to adjust, based on a fusion effect of the complete images of the plurality of preset elements, the complete image of at least one preset element of the plurality of preset elements to obtain a corrected complete image of each of the plurality of preset elements, generate the element image of each preset element based on the corrected complete image and the element display region of each preset element.

Alternatively or additionally, the description unit 2002 may be further configured to process, using a large language model, the multimedia data and the user information to determine the description words of the multimedia data.

Each of the receiving unit 2001, the description unit 2002, the generating unit 2003, the triggering unit, and the updating unit may be physically implemented by analog and/or digital circuits including one or more of a logic gate, an integrated circuit, a microprocessor, a microcontroller, a memory circuit, a passive electronic component, an active electronic component, an optical component, or the like. For example, a field programmable gate array (FPGA) may be used to implement custom logic that may include the functionality of the receiving unit 2001, the description unit 2002, the generating unit 2003, the triggering unit, the updating unit, and/or a combination thereof. As another example, a processor (e.g., one or more processors 2102 of FIG. 21) in combination with a memory (e.g., at least one memory 2101 of FIG. 21) may be used to execute one or more instructions to perform the functionality of the receiving unit 2001, the description unit 2002, the generating unit 2003, the triggering unit, and the updating unit.

FIG. 21 illustrates a block diagram of an electronic device, according to an embodiment of the present disclosure.

Referring to FIG. 21, the electronic device 2100 includes at least one memory 2101 and one or more processors 2102. The at least one memory 2101 may store computer-executable instructions therein, and when the computer-executable instructions are executed by the one or more processors 2102, individually or collectively, the instructions may cause the electronic device 2100 to perform an image generating method, according to embodiments of the disclosure described above.

For an example, the electronic device 2100 may be and/or may include, but not be limited to, a personal computer (PC), a tablet device, a personal digital assistant (PDA), a smartphone, a wearable device, a smart appliance, an IoT device, or other devices capable of executing the above instruction set. As used herein, the electronic device 2100 may not refer to a single electronic device, but may also be any device or collection of circuits capable of executing the instructions (or the instruction set) individually or in combination. The electronic device 2100 may also be part of an integrated control system or a system manager, and/or may be configured to be an electronic device connecting with a local or a remote device (e.g., via wireless transmission) by an interface.

In the electronic device 2100, the one or more processors 2102 may include a central processing unit (CPU), a graphic processing unit (GPU), a programmable logic device, a dedicated processor system, a microcontroller, and/or a microprocessor. For example and not as a limitation, the one or more processors 2102 may also include an analog processor, a digital processor, a microprocessor, a multi-core processor, a processor array, a network processor, and/or the like. That is, in an embodiment, the processor may include processing circuitry.

The one or more processors 2102 may run instructions and/or code stored in the at least one memory 2101, wherein the at least one memory 2101 may also store data for generating an image according to an embodiment of the present disclosure. For example, the at least one memory 2101 may store one or more preset image templates (e.g., the image template 300), one or more input resources (e.g., the data received by the receiving unit 2001) from users, and/or one or more media assets to be provided to the users. The instructions and/or data may also be sent and/or received over a network via a network interface device, wherein the network interface device may employ any known transmission protocol.

The at least one memory 2101 may be integrated with the one or more processors 2102, for example, by arranging random-access memory (RAM) and/or flash memory within an integrated circuit microprocessor. Alternatively or additionally, the at least one memory 2101 may include a separate device (e.g., one or more storage mediums), such as, but not limited to, an external disk drive, a storage array, or other storage devices which may be used by any storage and/or database system. The at least one memory 2101 and the one or more processors 2102 may be operationally coupled and/or may communicate with each other, for example, via input/output (I/O) ports, network connections, or the like, so that the one or more processors 2102 may access files and/or data stored in the at least one memory 2101.

In addition, the electronic device 2100 may also include a video display (e.g., LCD) and/or a user interface (such as, but not limited to, a keyboard, a mouse, a touch input device, or the like). All components of the electronic device 2100 may be connected to each other via a bus and/or a network.

According to embodiments of the present disclosure, a computer-readable storage medium storing instructions may also be provided, the instructions when executed by the one or more processors 2102, may cause the one or more processors 2102 to perform the image generating method, according to embodiments of the present disclosure described above. Examples of computer-readable storage medium may include, but not be limited to, read-only memory (ROM), programmable read-only memory (PROM), electrically erasable programmable read-only memory (EEPROM), RAM, dynamic RAM (DRAM), static RAM (SRAM), flash memory, non-volatile memory (NVM), compact disc (CD) ROM (CD-ROM), CD recordable (CD-R or CD+R), CD rewriteable (CD-RW or CD+RW), digital versatile disc (DVD) ROM (DVD-ROM), DVD recordable (DVD-R or DVD+R), DVD rewriteable (DVD-RW or DVD+RW), DVD RAM (DVD-RAM), Blu-ray disc (BD) ROM (BD-ROM), BD recordable (BD-R or BD-RE), BD-R Low-to-High (BD-R LTH), Blu-ray or optical disk memory, hard disk drive (HDD), solid state drive (SSD), card-based memory (such as, but not limited to, multimedia cards, Secure Digital (SD) cards and/or Extreme Digital (XD) cards), magnetic tapes, floppy disks, magneto-optical data storage devices, optical data storage devices, hard disks, solid state disks, and/or any other device, where the other device is configured to store the computer programs and any associated data, data files, and/or data structures in a non-transitory manner and to provide the computer programs and any associated data, data files, and/or data structures to a processor or computer, so that the processor or computer may execute the computer program. The computer program in the computer readable storage medium may run in an environment deployed in a computer device such as a client, a host, an agent, a server, or the like. Alternatively or additionally, the computer program and any associated data, data files and/or data structures may be distributed on a networked computer system such that the computer program and any associated data, data files and/or data structures may be stored, accessed, and/or executed in a distributed manner by one or more processors or computers.

According to an embodiment of the present disclosure, an image generating method may comprise receiving multimedia data and user information of a current user of the multimedia data. The image generating method may comprise determining description words of the multimedia data, based on the multimedia data and the user information. The image generating method may comprise generating a description image of the multimedia data, based on the description words. The image generating method may comprise applying the description image to a detail page of the multimedia data.

Additionally or alternatively, the generating of the description image may comprise obtaining an image template comprising a plurality of preset elements. The generating of the description image may comprise determining, for each preset element of the plurality of preset elements, element description words based on the description words. The generating of the description image may comprise generating, for each preset element of the plurality of preset elements, an element image based on the element description words of the preset element. The generating of the description image may comprise generating the description image of the multimedia data based on the element images of the plurality of preset elements.

Additionally or alternatively, the generating of the description image may comprise determining, based on the element images of the plurality of preset elements, dynamic element images and static element images. The generating of the description image may comprise fusing the dynamic element images to a dynamic layer and fusing the static element images to a static layer, wherein the dynamic layer is capable of being regenerated. The generating of the description image may comprise merging the dynamic layer and the static layer to the description image of the multimedia data.

Additionally or alternatively, the determining of the dynamic element images and the static element images may comprise acquiring scenario information related to the current user and a viewing behavior of the current user. The determining of the dynamic element images and the static element images may comprise determining, based on the scenario information, the dynamic element images and the static element images from among the element images of the plurality of preset elements. The determining of the dynamic element images and the static element images may comprise regenerating the dynamic layer based on changes to the scenario information.

Additionally or alternatively, the image generating method may comprise receiving updated scenario information. The image generating method may comprise determining, based on the updated scenario information, whether to trigger at least one of an update scenario mode or a reset scenario mode. The image generating method may comprise, based on the determining to trigger the update scenario mode, adjusting, based on the updated scenario information, the dynamic element images to obtain updated dynamic element images, fusing the updated dynamic element images to an updated dynamic layer, and merging the updated dynamic layer and the static layer to an updated description image of the multimedia data. The image generating method may comprise, based on the determining to trigger the reset scenario mode, receiving new multimedia data and new user information of the current user of the new multimedia data, determining new description words of the new multimedia data, and generating a new description image of the new multimedia data, based on the new description words.

Additionally or alternatively, the scenario information may comprise at least one of a multimedia type, a user profile, camera sensor data, a playback progress, or a playback mode. The multimedia type may comprise a multimedia set and an independent multimedia. The multimedia set may indicate whether the multimedia data comprises a plurality of multimedia files. The independent multimedia may indicate whether the multimedia data contains only one multimedia file. The user profile may comprise at least one of a viewing preference, a gender, or an age. The camera sensor data may comprise at least one of user identification, a viewing distance, background noise, or ambient light. The playback mode may comprise at least one of a child mode, an elderly mode, a standard mode, or an office mode.

Additionally or alternatively, each preset element of the plurality of preset elements may comprise element configuration information. The element configuration information may comprise an element name and an element display region that represents a display region at least partially covered by the corresponding element image in the description image. The generating, for each preset element of the plurality of preset elements, of the element image may comprise generating a complete image based on the element description words and the element configuration information of the preset element, a size of the complete image matching a size of the description image. The generating, for each preset element of the plurality of preset elements, of the element image may comprise generating the element image based on the complete image and the element display region of the preset element.

Additionally or alternatively, the generating, for each preset element of the plurality of preset elements, of the element image may comprise adjusting, based on a fusion effect of the complete images of the plurality of preset elements, the complete image of at least one preset element of the plurality of preset elements to obtain a corrected complete image. The generating, for each preset element of the plurality of preset elements, of the element image may comprise generating the element image of the preset element based on the corrected complete image and the element display region of the preset element.

Additionally or alternatively, the determining of the description words of the multimedia data may comprise processing, using a large language model, the multimedia data and the user information to determine the description words of the multimedia data.

According to an embodiment of the present disclosure, an image generating apparatus may comprise one or more processors comprising processing circuitry. The image generating apparatus may comprise memory, comprising one or more storage mediums, storing instructions. The instructions, when executed by the one or more processors individually or collectively, may cause the image generating apparatus to receive multimedia data and user information of a current user of the multimedia data. The instructions, when executed by the one or more processors individually or collectively, may cause the image generating apparatus to determine description words of the multimedia data, based on the multimedia data and the user information. The instructions, when executed by the one or more processors individually or collectively, may cause the image generating apparatus to generate a description image of the multimedia data, based on the description words. The instructions, when executed by the one or more processors individually or collectively, may cause the image generating apparatus to apply the description image to a detail page of the multimedia data.

Additionally or alternatively, the instructions, when executed by the one or more processors individually or collectively, may cause the image generating apparatus to obtain an image template comprising a plurality of preset elements. The instructions, when executed by the one or more processors individually or collectively, may cause the image generating apparatus to determine, for each preset element of the plurality of preset elements, element description words based on the description words. The instructions, when executed by the one or more processors individually or collectively, may cause the image generating apparatus to generate, for each preset element of the plurality of preset elements, an element image based on the element description words of the preset element. The instructions, when executed by the one or more processors individually or collectively, may cause the image generating apparatus to generate the description image of the multimedia data based on the element images of the plurality of preset elements.

Additionally or alternatively, the instructions, when executed by the one or more processors individually or collectively, may cause the image generating apparatus to determine, based on the element images of the plurality of preset elements, dynamic element images and static element images. The instructions, when executed by the one or more processors individually or collectively, may cause the image generating apparatus to fuse the dynamic element images to a dynamic layer and fuse the static element images to a static layer, wherein the dynamic layer is capable of being regenerated. The instructions, when executed by the one or more processors individually or collectively, may cause the image generating apparatus to merge the dynamic layer and the static layer to the description image of the multimedia data.

Additionally or alternatively, the instructions, when executed by the one or more processors individually or collectively, may cause the image generating apparatus to acquire scenario information related to the current user and a viewing behavior of the current user. The instructions, when executed by the one or more processors individually or collectively, may cause the image generating apparatus to determine, based on the scenario information, the dynamic element images and the static element images from among the element images of the plurality of preset elements. The instructions, when executed by the one or more processors individually or collectively, may cause the image generating apparatus to regenerate the dynamic layer based on changes to the scenario information.

Additionally or alternatively, the instructions, when executed by the one or more processors individually or collectively, may cause the image generating apparatus to receive updated scenario information. The instructions, when executed by the one or more processors individually or collectively, may cause the image generating apparatus to determine, based on the updated scenario information, whether to trigger at least one of an update scenario mode or a reset scenario mode. The instructions, when executed by the one or more processors individually or collectively, may cause the image generating apparatus to, based on a determination to trigger the update scenario mode, adjust, based on the updated scenario information, the dynamic element images to obtain updated dynamic element images, fuse the updated dynamic element images to an updated dynamic layer, and merge the updated dynamic layer and the static layer to an updated description image of the multimedia data. The instructions, when executed by the one or more processors individually or collectively, may cause the image generating apparatus to, based on a determination to trigger the reset scenario mode, receive new multimedia data and new user information of the current user of the new multimedia data, determine new description words of the new multimedia data, and generate a new description image of the new multimedia data, based on the new description words.

Additionally or alternatively, the scenario information may comprise at least one of a multimedia type, a user profile, camera sensor data, a playback progress, or a playback mode. The multimedia type may comprise a multimedia set and an independent multimedia. The multimedia set may indicate whether the multimedia data comprises a plurality of multimedia files. The independent multimedia may indicate whether the multimedia data contains only one multimedia file. The user profile may comprise at least one of a viewing preference, a gender, or an age. The camera sensor data may comprise at least one of user identification, a viewing distance, background noise, or ambient light. The playback mode may comprise at least one of a child mode, an elderly mode, a standard mode, or an office mode.

Additionally or alternatively, each preset element of the plurality of preset elements may comprise element configuration information. The element configuration information may comprise an element name and an element display region that represents a display region at least partially covered by the corresponding element image in the description image. The instructions, when executed by the one or more processors individually or collectively, may cause the image generating apparatus to generate, for each preset element of the plurality of preset elements, a complete image of the preset element based on the element description words and the element configuration information of the preset element, a size of the complete image matching a size of the description image. The instructions, when executed by the one or more processors individually or collectively, may cause the image generating apparatus to generate, for each preset element of the plurality of preset elements, the element image of the preset element based on the complete image and the element display region of the preset element.

Additionally or alternatively, the instructions, when executed by the one or more processors individually or collectively, may cause the image generating apparatus to adjust, based on a fusion effect of the complete images of the plurality of preset elements, the complete image of at least one preset element of the plurality of preset elements to obtain a corrected complete image of each preset element of the plurality of preset elements. The instructions, when executed by the one or more processors individually or collectively, may cause the image generating apparatus to generate the element image of each preset element of the plurality of preset elements based on the corrected complete image and the element display region of the preset element.

Additionally or alternatively, the instructions, when executed by the one or more processors individually or collectively, may cause the image generating apparatus to process, using a large language model, the multimedia data and the user information to determine the description words of the multimedia data.

Additionally or alternatively, the instructions, when executed by the one or more processors individually or collectively, may cause the image generating apparatus to generate the description image of the multimedia based on a convolutional neural network (CNN).

According to an embodiment of the present disclosure, an electric apparatus may comprise at least one processor and at least one memory storing computer-executable instructions. The computer-executable instructions, when executed by the at least one processor, may cause the electronic apparatus to receive multimedia data and user information of a current user of the multimedia data. The computer-executable instructions, when executed by the at least one processor, may cause the electronic apparatus to determine description words of the multimedia data, based on the multimedia data and the user information. The computer-executable instructions, when executed by the at least one processor, may cause the electronic apparatus to generate a description image of the multimedia data, based on the description words. The computer-executable instructions, when executed by the at least one processor, may cause the electronic apparatus to apply the description image to a detail page of the multimedia data. The computer-executable instructions, when executed by the at least one processor, may cause the electronic apparatus to determine, based on receipt of updated scenario information, whether to trigger at least one of an update scenario mode or a reset scenario mode according to the updated scenario information. The computer-executable instructions, when executed by the at least one processor, may cause the electronic apparatus to, based on a determination to trigger the update scenario mode, adjust, based on the updated scenario information, an updated description image of the multimedia data. The computer-executable instructions, when executed by the at least one processor, may cause the electronic apparatus to, based on a determination to trigger the reset scenario mode, receive new multimedia data and new user information of the current user of the new multimedia data, determine new description words of the new multimedia data, generate a new description image of the new multimedia data, based on the new description words. The computer-executable instructions, when executed by the at least one processor, may cause the electronic apparatus to apply the new description image to the detail page of the multimedia data.

According to an embodiment of the present disclosure, a non-transitory computer-readable storage medium may store computer-executable instructions that, when executed by at least one processor of a device, cause the device to perform any one of the image generating methods described herein.

According to embodiments of the present disclosure, a computer program product including computer instructions may be provided, wherein the computer instructions, when executed by at least one processor, perform the image generating method according to embodiments of the present disclosure described above.

Embodiments of the disclosure may readily come to the mind of those skilled in the art upon consideration of the present disclosure and practice of the technical concepts disclosed herein. The present disclosure is intended to cover any variations, uses, or adaptations of the present disclosure that follow the general principles of the disclosure and include commonly known and/or customary technical means in the art that are not disclosed herein. The specification and the embodiments are merely examples, and the scope and spirit of the present disclosure is indicated by the following claims.

It is to be understood that the disclosure is not limited to the precise structure already described above and illustrated in the accompanying drawings, and that various modifications and changes may be made without departing from its scope. The scope of the present disclosure is limited only by the appended claims.

What is claimed is:

1. An image generating method, the image generating method comprising:
receiving multimedia data and user information of a current user of the multimedia data;
determining description words of the multimedia data, based on the multimedia data and the user information;
generating a description image of the multimedia data, based on the description words; and
applying the description image to a detail page of the multimedia data.

2. The image generating method of claim 1, wherein the generating of the description image comprises:
obtaining an image template comprising a plurality of preset elements;
determining, for each preset element of the plurality of preset elements, element description words based on the description words;
generating, for each preset element of the plurality of preset elements, an element image based on the element description words of the preset element; and
generating the description image of the multimedia data based on the element images of the plurality of preset elements.

3. The image generating method of claim 2, wherein the generating of the description image further comprises:
determining, based on the element images of the plurality of preset elements, dynamic element images and static element images;
fusing the dynamic element images to a dynamic layer and fusing the static element images to a static layer, wherein the dynamic layer is capable of being regenerated; and
merging the dynamic layer and the static layer to the description image of the multimedia data.

4. The image generating method of claim 3, wherein the determining of the dynamic element images and the static element images comprises:
acquiring scenario information related to the current user and a viewing behavior of the current user;
determining, based on the scenario information, the dynamic element images and the static element images from among the element images of the plurality of preset elements; and
regenerating the dynamic layer based on changes to the scenario information.

5. The image generating method of claim 4, further comprising:
receiving updated scenario information;
determining, based on the updated scenario information, whether to trigger at least one of an update scenario mode or a reset scenario mode;
based on the determining to trigger the update scenario mode, adjusting, based on the updated scenario information, the dynamic element images to obtain updated dynamic element images, fusing the updated dynamic element images to an updated dynamic layer, and merging the updated dynamic layer and the static layer to an updated description image of the multimedia data; and
based on the determining to trigger the reset scenario mode, receiving new multimedia data and new user information of the current user of the new multimedia data, determining new description words of the new multimedia data, and generating a new description image of the new multimedia data, based on the new description words.

6. The image generating method of claim 4, wherein the scenario information comprises at least one of a multimedia type, a user profile, camera sensor data, a playback progress, or a playback mode,
wherein the multimedia type comprises a multimedia set and an independent multimedia,
wherein the multimedia set indicates whether the multimedia data comprises a plurality of multimedia files,
wherein the independent multimedia indicates whether the multimedia data contains only one multimedia file,
wherein the user profile comprises at least one of a viewing preference, a gender, or an age,
wherein the camera sensor data comprises at least one of user identification, a viewing distance, background noise, or ambient light, and
wherein the playback mode comprises at least one of a child mode, an elderly mode, a standard mode, or an office mode.

7. The image generating method of claim 2, wherein each preset element of the plurality of preset elements comprises element configuration information,
wherein the element configuration information comprises an element name and an element display region that represents a display region at least partially covered by the corresponding element image in the description image, and
wherein the generating, for each preset element of the plurality of preset elements, of the element image comprises:
generating a complete image based on the element description words and the element configuration information of the preset element, a size of the complete image matching a size of the description image; and
generating the element image based on the complete image and the element display region of the preset element.

8. The image generating method of claim 7, wherein the generating, for each preset element of the plurality of preset elements, of the element image further comprises:
adjusting, based on a fusion effect of the complete images of the plurality of preset elements, the complete image of at least one preset element of the plurality of preset elements to obtain a corrected complete image; and
generating the element image of the preset element based on the corrected complete image and the element display region of the preset element.

9. The image generating method of claim 1, wherein the determining of the description words of the multimedia data comprises:
processing, using a large language model, the multimedia data and the user information to determine the description words of the multimedia data.

10. An image generating apparatus, comprising:
one or more processors comprising processing circuitry; and
memory, comprising one or more storage mediums, storing instructions,
wherein the instructions, when executed by the one or more processors individually or collectively, cause the image generating apparatus to:
receive multimedia data and user information of a current user of the multimedia data;
determine description words of the multimedia data, based on the multimedia data and the user information;
generate a description image of the multimedia data, based on the description words; and
apply the description image to a detail page of the multimedia data.

11. The image generating apparatus of claim 10, wherein the instructions, when executed by the one or more processors individually or collectively, further cause the image generating apparatus to:
obtain an image template comprising a plurality of preset elements;
determine, for each preset element of the plurality of preset elements, element description words based on the description words;
generate, for each preset element of the plurality of preset elements, an element image based on the element description words of the preset element; and
generate the description image of the multimedia data based on the element images of the plurality of preset elements.

12. The image generating apparatus of claim 11, wherein the instructions, when executed by the one or more processors individually or collectively, further cause the image generating apparatus to:
determine, based on the element images of the plurality of preset elements, dynamic element images and static element images;
fuse the dynamic element images to a dynamic layer and fuse the static element images to a static layer, wherein the dynamic layer is capable of being regenerated; and
merge the dynamic layer and the static layer to the description image of the multimedia data.

13. The image generating apparatus of claim 12, wherein the instructions, when executed by the one or more processors individually or collectively, further cause the image generating apparatus to:
acquire scenario information related to the current user and a viewing behavior of the current user;
determine, based on the scenario information, the dynamic element images and the static element images from among the element images of the plurality of preset elements; and
regenerate the dynamic layer based on changes to the scenario information.

14. The image generating apparatus of claim 13, wherein the instructions, when executed by the one or more processors individually or collectively, further cause the image generating apparatus to:
receive updated scenario information;
determine, based on the updated scenario information, whether to trigger at least one of an update scenario mode or a reset scenario mode;
based on a determination to trigger the update scenario mode, adjust, based on the updated scenario information, the dynamic element images to obtain updated dynamic element images, fuse the updated dynamic element images to an updated dynamic layer, and merge the updated dynamic layer and the static layer to an updated description image of the multimedia data; and
based on a determination to trigger the reset scenario mode, receive new multimedia data and new user information of the current user of the new multimedia data, determine new description words of the new multimedia data, and generate a new description image of the new multimedia data, based on the new description words.

15. The image generating apparatus of claim 13, wherein the scenario information comprises at least one of a multimedia type, a user profile, camera sensor data, a playback progress, or a playback mode,
wherein the multimedia type comprises a multimedia set and an independent multimedia,
wherein the multimedia set indicates whether the multimedia data comprises a plurality of multimedia files,
wherein the independent multimedia indicates whether the multimedia data contains only one multimedia file,
wherein the user profile comprises at least one of a viewing preference, a gender, or an age,
wherein the camera sensor data comprises at least one of user identification, a viewing distance, background noise, or ambient light, and
wherein the playback mode comprises at least one of a child mode, an elderly mode, a standard mode, or an office mode.

16. The image generating apparatus of claim 11, wherein each preset element of the plurality of preset elements comprises element configuration information,
wherein the element configuration information comprises an element name and an element display region that represents a display region at least partially covered by the corresponding element image in the description image, and
wherein the instructions, when executed by the one or more processors individually or collectively, further cause the image generating apparatus to:
generate, for each preset element of the plurality of preset elements, a complete image of the preset element based on the element description words and the element configuration information of the preset element, a size of the complete image matching a size of the description image; and
generate, for each preset element of the plurality of preset elements, the element image of the preset element based on the complete image and the element display region of the preset element.

17. The image generating apparatus of claim 16, wherein the instructions, when executed by the one or more processors individually or collectively, further cause the image generating apparatus to:
adjust, based on a fusion effect of the complete images of the plurality of preset elements, the complete image of at least one preset element of the plurality of preset elements to obtain a corrected complete image of each preset element of the plurality of preset elements; and
generate the element image of each preset element of the plurality of preset elements based on the corrected complete image and the element display region of the preset element.

18. The image generating apparatus of claim 10, wherein the instructions, when executed by the one or more processors individually or collectively, further cause the image generating apparatus to:
process, using a large language model, the multimedia data and the user information to determine the description words of the multimedia data.

19. The image generating apparatus of claim 10, wherein the instructions, when executed by the one or more processors individually or collectively, further cause the image generating apparatus to:
generate the description image of the multimedia based on a convolutional neural network (CNN).

20. A non-transitory computer-readable storage medium storing computer-executable instructions that, when executed by at least one processor of a device, cause the device to perform the image generating method of claim 1.
